(19) United States
(12) Patent Application Publication
(10) Pub. No.: US 2002/0095389 A1
(43) Pub. Date: Jul. 18, 2002

(54) Method, apparatus and system for identity authentication

(76) Inventor: Robert Vallee Gaines, Houston, TX (US)

Correspondence Address: Carol M. Nielsen, Gardere Wynne Sewell LLP, Patent Section (H), 1601 Elm Street, Suite 3000, Dallas, TX, 75201, US

(21) Appl. No.: 10/032,265

(22) Filed: Dec. 21, 2001

Related U.S. Application Data
(63) Continuation-in-part of application No. 09/680,248, filed on Oct. 5, 2000.
(60) Provisional application No. 60/157,749, filed on Oct. 5, 1999.

(51) Int. Cl. G06F 17/60

(52) U.S. Cl. 705/67

(57) ABSTRACT

A device, a method and a computer system to replace a bulky low tech, non-secure wallet with built-in security protocol is provided. A robust, high-memory capacity, portable miniaturized computer system includes a processing unit, memory, power source, reader and interface. The miniaturized computer is capable of storing large amounts of data and transmitting this data to a reader via a robust button interface, wireless transmitter or USB port or other connection configuration. The data contained within the computer is safeguarded by the need of the owner to access the data or remotely shut the computer down.

### CROSS REFERENCE TO RELATED APPLICATION

This application is a continuation-in-part of the provisional patent application U.S. Pat. App. Ser. No. 60/157,749 filed Nov. 5, 1999 and U.S. pat. app. Ser. No. 09/680,248 filed Oct. 5, 2000.

### BACKGROUND OF THE INVENTION

One of the biggest challenges facing today's businesses is security, i.e., security of corporate data, security of financial transactions, and the personal privacy of employees and clients. Companies and individuals alike are consistently looking for ways to control access to their data and assure safe and secure transactions over the Internet, the company network, or in the market place.

Furthermore, the society is increasingly faced with theft and loss of privacy. Credit card fraud is an everyday occurrence in the market place. “Swiping,” the act of covertly swiping a credit card through a reader to steal the card's banking data, is used to make purchases over the phone or Internet, and/or duplicate the credit card. Stealing the receipt and copying down the number and expiration date to use for purchases, a cruder form of theft, is common place.

Phone card theft is also running rampant. Specialized thieves position themselves in front of payphones in such public places as airports and hotels. From strategic positions they look over the shoulder of customers and copy or memorize their account number and PIN as they enter them into the phone's keypad. The numbers are then sold to run up huge long distance phone calls and the like.

Several attempts have been made to stop these illegal transactions. For example, credit card companies have issued cards with holograms in an attempt to slow down fraud. These efforts fail for many reasons. First, a sales clerk must differentiate between a real hologram and a fake one and this task requires specialized training. Furthermore, photo IDs do not work unless the contrast between the customer and the IP is apparent. Another attempt to avoid illegal transactions includes the use of some form of password to allow the use of credit cards. But as mentioned above, thieves have learned to easily acquire these Personal Identification Numbers.

The advent of “Smart Cards” is also an attempt to resolve fraud and identity theft. These credit card sized devices contain a computer chip designed to hold and disseminate information. These cards require an expensive reader and do not hold large amounts of information.

Large memory devices do not lend themselves to easy access or portability. Disk drives or “Zip” disks even micro-drives require large cumbersome mechanical devices to read them. Memory chips such as compact flash, multi-media memory, smart media, memory stick or similar devices do not have robust interfaces. Rather delicate slot and pin connections or the USB port are required. While solving the lack of memory, none of these devices have the robustness to withstand repeated hard use.

Today many devices are being used to access and store data. Personal data assistants (PDAs), cellular phones, pagers and smart cards. All of these devices need memory to store their data, a redundant expense. In fact the data stored is often the same over and over again, such as names, addresses, email addresses, calendars, to do lists, etc. In order for the person to keep current they constantly need to synchronize these devices with one another often resulting in lost or incorrect information.

More recently the credit card companies have employed sophisticated software to track and monitor customer's buying habits, such as geographical area, amount spent per month, etc. These programs cost a lot of money to maintain and do not stop a fraudulent purchase in progress as fraud is analyzed after the fact. Another means of verifying identity includes using biometric information on the card itself. For example, the form of an actual fingerprint is encoded on a bar code or magnetic strip. The low memory capabilities of prior art devices, however, prevents the storage of a complete fingerprint. Furthermore, because of the nature of the medium, real time changes or updates are impossible.

A need exists, therefore, for a safer and securer method, apparatus and system for authentication of a person.

### BRIEF SUMMARY OF THE INVENTION

The present invention is a portable miniaturized computer, a computer system and method to retrieve and access personal data including identification, financial data and a wide variety of miscellaneous information in an easily portable and securable device designed to replace a person's wallet.

The portable miniaturized computer for authenticating the identity of a person and to process transactions that require proof of identification and access to other personal data of the subject invention comprises a first processor having a high capacity memory having the personal data maintained in the memory and an interface for communicating personal data from a receiver to the first processor and transmitting data to a remote device.

The subject invention also includes a computer system for authenticating identity of person and includes the miniaturized computer and a remote device having a reader and an interpreter. The interpreter has a second processor for authorizing an action or a transaction. The computer system may also include a remote processing unit having a third processor communicably linked to the remote device for higher level of security.

A method in a computer system for authenticating the identity of a person, the computer system having a miniaturized computer comprising a memory for storing personal data, an interface and a first processor for receiving and comparing personal data at various security levels, the method of authentication comprising the steps of receiving personal data through the interface of the miniaturized computer, verifying personal data by comparing the personal data received to personal data maintained in the memory of the miniaturized computer and displaying the authentication result.

The method includes the use of security protocols, procedures, and administrative functions that allow the owner to store, retrieve, and access their information and execute certain financial transactions such as purchases, money transfers and account balances electronically at high speeds. Information is securely stored in data fields in the device. A data field may contain the owner's name, medical information, an address book and credit card information. The owner, via security protocols, controls access to these data fields. These security protocols consist of administrative procedures, passwords, biometric data i.e. fingerprints, and identity confirmation procedures.

The portable miniaturized computer is designed to replace a wallet. The miniaturized computer is capable of receiving, storing and outputting large amounts of data via the interface. The interface preferably includes a tansmitter/receiver for inputting and outputting personal data. Data is sent from the computer via a mechanical interface, a wireless transmitter, USB port or other connection configuration.

The subject invention is particularly useful prior to processing a payment for a purchase transaction. For example, a form of payment is requested for the purchase transaction, data is received about the form of payment from a computer, and data about the form of payment and person making the transaction is authenticated.

The system for authenticating the identity of a person in accordance with the present invention includes a portable, miniaturized computer having a high capacity memory for storing personal data and an interface for retrieving and sending the data. The interface is communicably linked to the computer. The system further includes a remote processing unit for comparing personal data such as an identifier code, password or biometric criteria to the data maintained on the computer. The remote processing unit is communicably linked to a remote device that is further linked with the interface of the miniaturized computer.

The miniaturized computer of the subject invention has a memory for storing data and a unique identifier code that is etched inside the miniaturized computer. It further contains a computer chip for processing and encrypting the data and a power source for powering the memory and the computer chip. In the preferred embodiment, the data contains information about the customer's identity. The system may authenticate the identity of an individual by a wide variety of criteria including password and/or biometric identification.

The present invention resolves the problems with credit card theft and identity theft by utilizing several security level protocols that are easily remembered or accessed. As a result, various payment instruments are stored more securely. The present invention also allows multiple credit cards, electronic cash, phone cards and digital certificates to be stored in one electronic place. Information such as photos, name, phone number, address, music files, business cards, address book and so on which may be accessed on a public, semi-private or private basis with or without password or biometric authentication based on the customer's needs. The present invention further allows real time read/write functions. Purchase transactions may be stored in the memory for future reference.

The invention provides a method to positively identify the owner of the device for a variety of applications including access to secure buildings, files or even to start cars. Digital signatures on contracts and purchases would be bound and verified using the security protocols outlined herein. While signatures can be forged, biometric forgery is much more difficult.

The miniaturized computer of the present invention is used to positively identify an owner of the device. The subject invention is versatile and can be used in democratic vote tabulation. The identification number of the chip along with the biometric identification verification allows for unique tagging of an owner. Voting polls can use this system to track and confirm that people have voted.

The present invention is also a system for authenticating the identity of a person for the purpose of completing a financial transaction, voting in an election, access or opening of doors, signing of documents, etc. The system consists of a miniaturized computer, a remote device and a remote processing unit. The remote device comprises a second processor, a reader and interpreter. The reader is capable of accepting data from the miniaturized computer and is communicably linked to an interpreter capable of processing the data. A remote processor has a third processor and may include a remote database for storage of data. An alternate interface used for verifying identity is via a biometric scanner capable of scanning fingerprints, DNA, eye retinas, etc.,

Several existing devices may be combined into a new high memory capacity device with a robust, multiple use, touch and go interface. The simple button touch interface replaces the delicate, mechanical slot and pin connections. The touch interface is used to access the stored information in a memory medium such as smart card, compact flash, multimedia memory, smart media, memory stick or micro-drive.

The high speed, high capacity memory of the miniaturized computer may be in the form of jewelry or body wear. This body wear would contain a memory media, first processor, interface device and an interface such as a wireless transmitter. The body wear would be configured so that it could interface with a variety of devices such as cellular phones, PDAs, personal computers and pagers. Since the body wear provides a larger memory media storage capacity the devices could dispense with the redundant memory resulting in a reduced cost for the device.

Other features and advantages of the present invention shall be apparent to those of ordinary skill in the art upon reference to the following detailed description taken in conjunction with the accompanying drawings.

### BRIEF DESCRIPTION OF SEVERAL VIEWS OF THE DRAWINGS

For a better understanding of the invention, and to show by way of example how the same may be carried into effect, reference is now made to the detailed description of the invention along with the accompanying figures in which corresponding numerals in the different figures refer to corresponding parts and in which:

FIG. 1A depicts a top view of a miniaturized computer in accordance with the present invention;

FIG. 1B depicts a side profile of the miniaturized computer in accordance with the present invention;

FIG. 2 depicts a remote device in accordance with the present invention;

FIG. 3 depicts another remote device shown in FIG. 2;

FIG. 4 depicts a flow diagram of a single embodiment of a registration process in accordance with the present invention;

FIG. 5 depicts a block diagram of an authentication computer system in a retail purchase environment in accordance with the second embodiment of the present invention;

FIG. 6 depicts a block diagram of an authentication system in a home purchase environment in accordance with the third embodiment of the present invention;

FIGS. 7-15 illustrates a method of identification authentication in accordance with the present invention; and

FIG. 16 depicts a block diagram of a system that uses the miniaturized computer in conjunction with an ATM machine in accordance with the fourth embodiment of the present invention.

FIGS. 17-22 illustrate a method where the miniaturized computer of the present invention receives and transfers real cash and virtual cash.

FIG. 23 depicts a remote device to be used in connection with the miniaturized computer of the subject invention..

FIG. 24 depicts the miniaturized computer with button, USB and high density memory pack and processor chip.

FIG. 25 depicts a data wrist rocket high memory body wear.

FIG. 26 depicts an access wand USB/ibutton interface.

FIGS. 27-32 depicts the process for making changes and modifications to the virtual wallet and the subsequent verification of the new data and identity.

FIG. 33 depicts the method of authentication of digital signatures.

FIG. 34 depicts the method of authentication of the present invention used in connection with the voter registration and voting process.

FIG. 35 depicts yet another embodiment of the high memory capacity of the miniaturized computer of the subject invention.

FIG. 36 depicts yet another embodiment of the high memory capacity miniature computer using only a wireless or touchless interface.

FIG. 37 is a general flow chart of data for the subject invention.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. For example, in addition to identification authentication of financial transactions, the present invention is capable of storing all kinds of data and therefore is able to authenticate anything that needs security and verification including cars, home doors, garages, computers, etc.

The present invention has many advantages. Problems with credit card theft and identity theft are resolved by utilizing several security protocols. As a result, various payment instruments are stored utilizing the present invention and the miniaturized computer then functions as a virtual wallet.

The present invention allows multiple credit cards, electronic cash, phone cards and digital certificates to be stored in one electronic place. The present invention can also contain user information such as photos, name, phone number, address, music files, business cards, address book and so on. This information can be public, semi-private or private allowing access with or without password or biometric authentication based on the customer's needs. The present invention also allows purchase transactions to be stored in the memory for future reference. The present invention further allows a real time read/write functions.

A computer system for authenticating identity of person comprises a portable miniaturized computer having a high capacity memory, first processor and an interface for retrieving and sending personal data. The interface is communicably linked to the miniaturized computer and a remote device. The remote device comprises a second processor, a reader and an interpreter for authorizing an action or transaction. The remote device may be communicably linked to a remote processing unit having a third processor for authenticating the personal data by comparing it to the personal data maintained in the remote processing unit. The miniaturized computer is preferably equipped with a robust easy to use interface may be communicably liked to a remote device via a mechanical device such as an button or USB connection or a wireless transmitter. The transmitter may send data via radio frequency, infrared or by sound transmission.

The identification authentication process of the present invention provides at least four different security protocols. The security protocols include: 1) a single unique identifier code is embedded in the portable miniaturized computer; 2) the use of a password; 3) the use of biometric identification criteria; and 4) a verification process of the unique identifier code, the customer's personal public data, selected password, and selected biometric identification criteria with a remote database. The unique identifier code may be a 128 key code encryption. It may also be hard coded or etched to on the computer chip itself.

The present invention can be used to authenticate and facilitate legal transactions. Because of the identity verification protocol, the invention includes digital signatures to facilitate functions such as document signatures. The built-in high capacity computer memory also allow for onboard tracking and transaction confirmation.

The present invention resolves the problem of mating large memory capacity devices to a robust high usage interface such as wireless transmission via radio frequency or infrared. This type of interface is preferred as it can be used over and over again without the fear of damage or missed connection. Nonetheless, the invention may utilize mechanical connections such as an i button or USB connection.

The present invention can add easy, accessible, external memory to a proliferation of hand held devices such as digital cameras, MP3 players and PDAs. Each device will not need to provide its own expensive internal memory. Since the memory can be shared among these devices there is no need to constantly update or try to synchronize the data between these devices.

In the first embodiment of the present invention, a portable miniaturized computer functions as a wallet. The portable miniaturized computer is complete with a first processor with a unique identifier code, e.g., using a 128 key code encryption, memory and an interface for sending and receiving data. The identifier code is etched on the computer chip itself.

The computer memory may contain several fields of data. These compartments are customizable by the owner. The following are examples of information and various fields of data.

Personal Public Data—Such as name, address, phone number, and/or digital photo id.

Credit Card Data—List of customer's credit or debit cards, their numbers and expiration dates as well as holding card company phone numbers, and promotions.

Medical Data—Personal emergency medical data, including doctor's name, insurance, medications, allergies, prescriptions, blood type, donor data, procedure authorizations.

Message Pad—Storage space for received messages.

Identification Data—social security number, driver's license, photo, fingerprint data, passport number.

Virtual Cash—Money purse that holds electronic currency.

Business Card—Customer-designated information that can be given out to merchants, restaurant owners, business clients, etc, similar to the business cards.

Administration—Holds the miniaturized computer's unique identifier code and language selection.

Pocket—Storage area for downloaded files to be accessed by other devices such as MP3 players, Palm PCs, digital cameras, computers, etc.

Encryption—Encryption data is stored and accessed here. This is where encryption keys are stored.

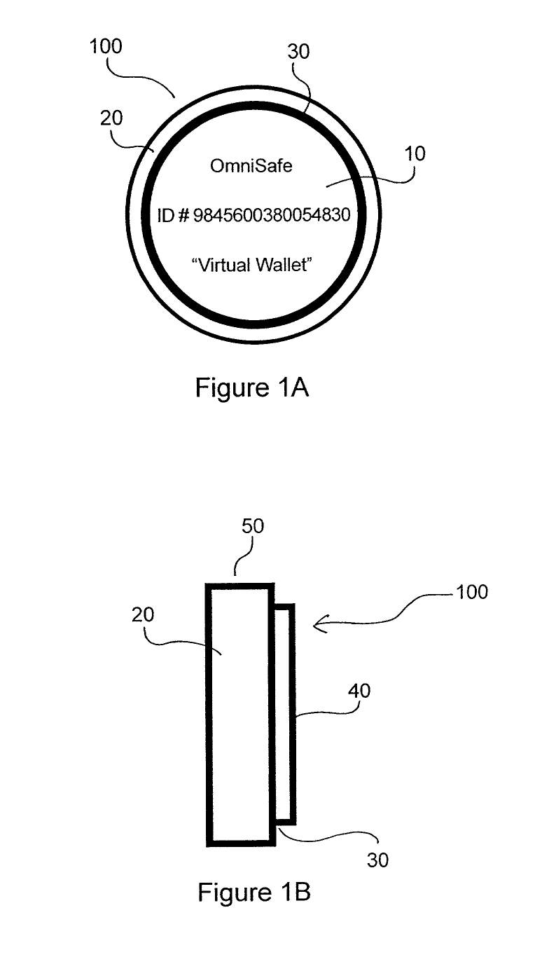

Referring to FIGS. 1A and 1B, in a first embodiment of the present invention, the portable miniaturized computer is shown contained in a safe 100. In one embodiment in accordance with the present invention, the safe 100 is comprised of a cylinder 10 attached to a ring 20. An insulating layer 30 is deposited between the cylinder 10 and the ring 20. The cylinder 10 has a contact surface 40. The ring 20 has a contact surface 50. The ring is preferably ⅝ inch diameter by ¼ inch thick. The safe 100 is made of a conductive material such as stainless steel.

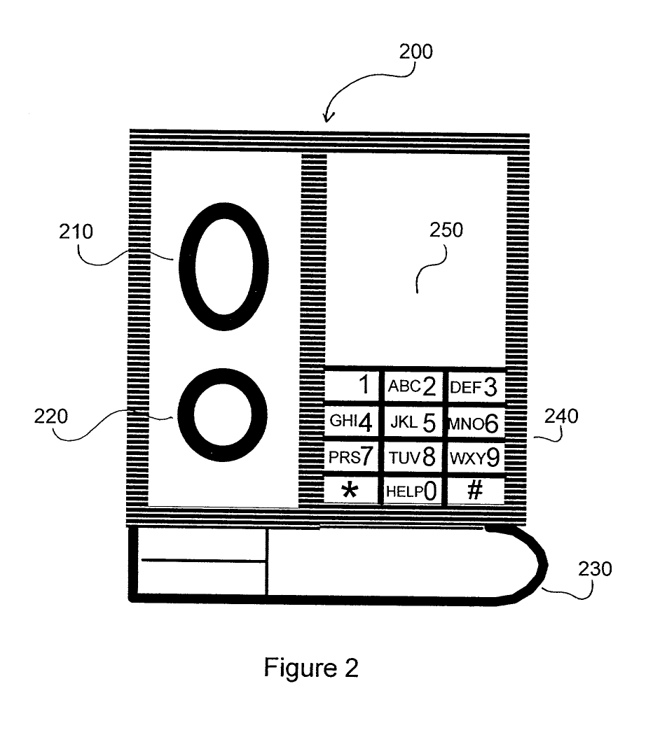

As shown in FIG. 2, a remote device 200 is capable of retrieving and transferring data to and from the portable miniaturized computer. The remote device 200 may also be capable of scanning biometrics from an individual. For example, the remote device is capable of scanning fingerprints, retina, DNA, face, and voice of an individual. The remote device, however, is incapable of storing data. This requires a second processor with memory.

The remote device 200 has contains has biometric scanner 210 and a data access port 220. The remote device 200 is communicably linked to an interpreter 230. The biometric scanner 210 is capable of scanning fingerprints, retina, DNA, face, and voice of an individual. A data access port 220 is capable of accessing data from the various compartments in the portable miniaturized computer. The interpreter 230 has software and hardware (second processor) necessary to perform the desired process. The interpreter 230 begins its process when data is accessed or biometrics is scanned. The interpreter 230 could be any stand-alone processor or could be a processor that resides in a device, such as a computer desktop, a handheld PC, a point to sale device, or an automated teller machine (ATM). The interpreter 230 does not have to be separate from the remote device 200. In this embodiment of the present invention, the interpreter 230 resides with in the remote device 200.

The interpreter 230 may utilize a wide range of software operating systems, including but not limited to DOS; Linux; Windows 3.11; Windows NT; Windows 95/98; Windows CE; QBasic; Pascal; Linux; Unix; Palm OS; C; MAC OS; C+++; Access; and Java. It is also capable of being adapted for use with new software as hardware processors are developed.

As shown in FIG. 2, the remote device 200 also includes an alpha-numeric touch pad 240. The alpha-numeric touch pad 240 enables individuals to enter passwords and various transactional information. The alpha-numeric touch pad 240 includes a display screen 250 in which transactions and prompts are displayed.

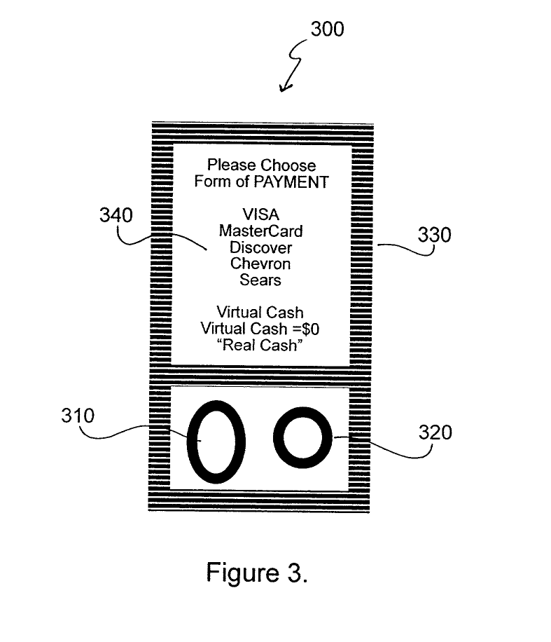

As shown in FIG. 3, as an alternative, the remote device 300 integrates a biometric scanner 310, a data access port 320, an interpreter 330 and a touch screen 340 into one remote device. The touch screen 340 enables individuals to enter passwords and various transactional information. The touch screen 340 acts as a visual interface that displays transactions and prompts.

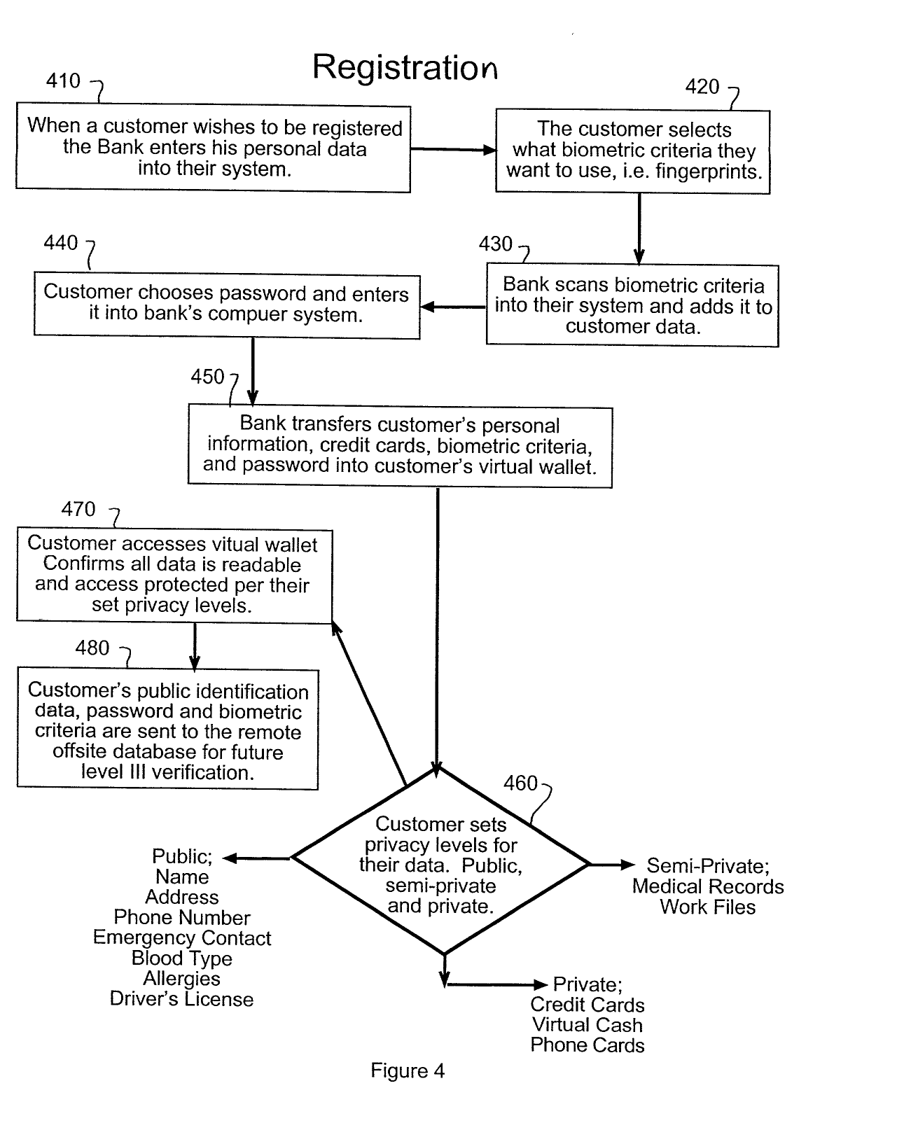

In a first embodiment of the subject invention, the portable miniaturized computer is utilized by a financial institution such as a bank. FIG. 4 describes how information is entered into the portable miniaturized computers in accordance with this embodiment of the present invention. First, the personal data is entered into the bank's computer system, e.g., via a computer 410. The personal data may include credit card information, medical information, and any other personal data including biometric identification criteria 420. As discussed above, biometric identification criteria can be used such as fingerprints, retina, DNA, face, and voice. Also, more than one biometric criteria may be selected. For example, two fingerprints may be selected, one from each hand. If one fingerprint is inaccessible, the other one may be scanned for identification. Afterwards, the preferred biometric identification criteria is scanned into the bank's computer system by a reader. Alternatively, the customer chooses a password, and the password is entered into the bank's computer system. The password is a customer selected digit or alpha-numeric number. As described in FIG. 4, the personal data, the preferred biometric identification criteria and the password are then stored in the portable miniaturized computer.

The information contained in the portable miniaturized computer has varying degrees of access. There are privacy levels for disclosing information to the public that are stored in the portable miniaturized computer. For example, the customer name, address, and phone number might be considered public data and therefore are accessible without requiring the customer's password or fingerprint. In this event, someone who finds the portable miniaturized computer may return it as the customer name, address and phone number are accessible by any reader. In another situation, the driver's license number stored in the portable miniaturized computer may be accessible to particular individuals without the need for a password or a fingerprint. Emergency medical information, such as blood type, doctor and insurance information might be considered semi-private data and therefore accessible only by fingerprint. This level of privacy enables medical personnel to quickly access the customer's emergency medical information even if the customer is unconscious. Similarly, credit cards and virtual cash are typically considered private data and accessible by both fingerprint and password, preventing any unauthorized access to this financial information.

As described in FIG. 4, once the information is stored in the portable miniaturized computer, the information is verified as being readable and accessible in accordance to the customer desired privacy level and its authentication requirement. For example, public data, such as name, address, and phone number, is accessible by merely touching the portable miniaturized computer and transmitting to the data access port 320 of a remote device. The accessibility of semi-private data, such as emergency medical information would be verified by touching the miniaturized computer to the data access port, selecting the option to access semi-private data, and providing the required fingerprint. The accessibility of private data, such as, credit cards and virtual cash, is verified by touching the miniaturized computer to the data access port, selecting the option to access private data and providing the required fingerprint and password.

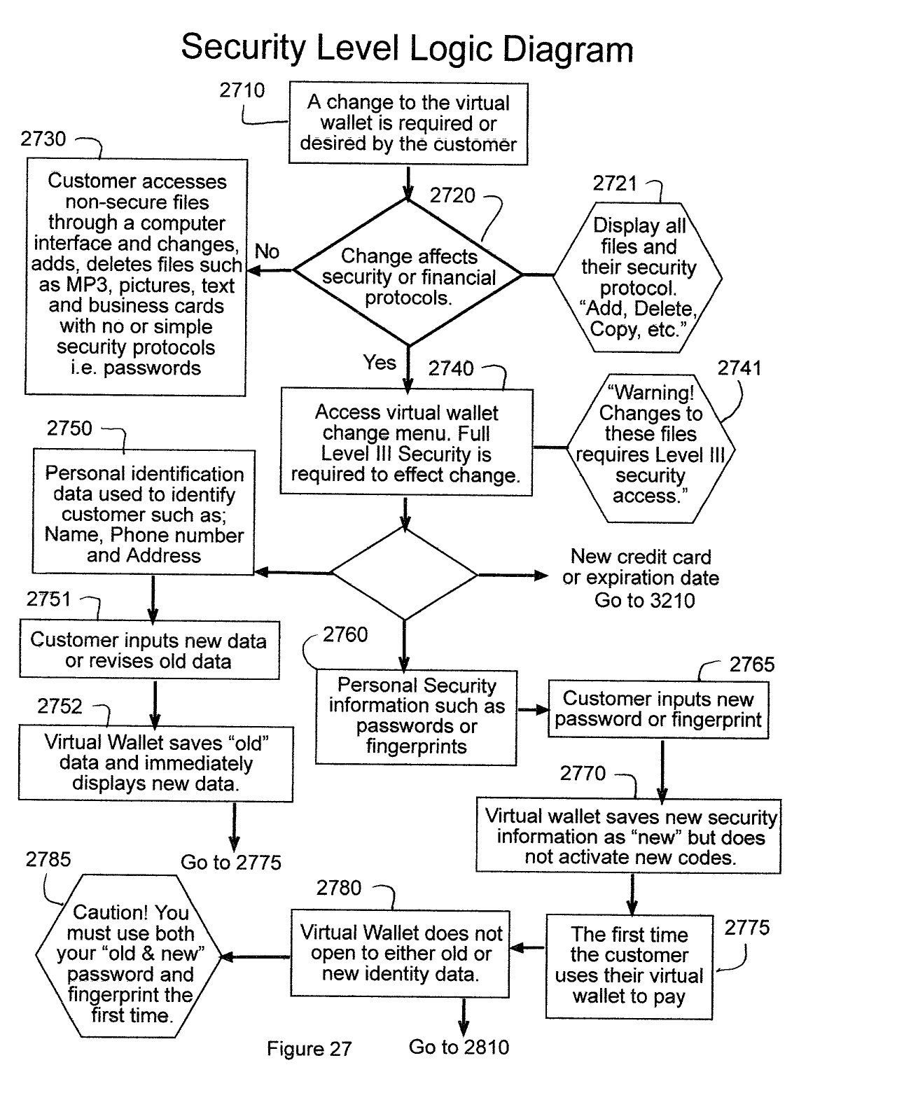

Following a successful verification process, the customer's public data along with the preferred biometric identification criteria and the password are sent to a remote processing unit having a remote database 480. This information is used in one of three levels of security. However, as shown in FIG. 27 step 2775, the first time the computer is used, the security level invoked is security level III. This event occurs after the initial activation, after addition or modification of data, or after the modification of security information such as password or fingerprint. The system accesses the remote database to confirm the content and identity of the virtual wallet and the owner as well as the identification of the accessing computer. Security level III verification occurs in this instance regardless of the security protocol set by a third party such as merchants or banks.

By comparing the embedded, encrypted identification number of the miniaturized computer with the identification number stored in the remote database access to the computer is confirmed. Other information about the accessing computer is also gathered and compared with the information on file.

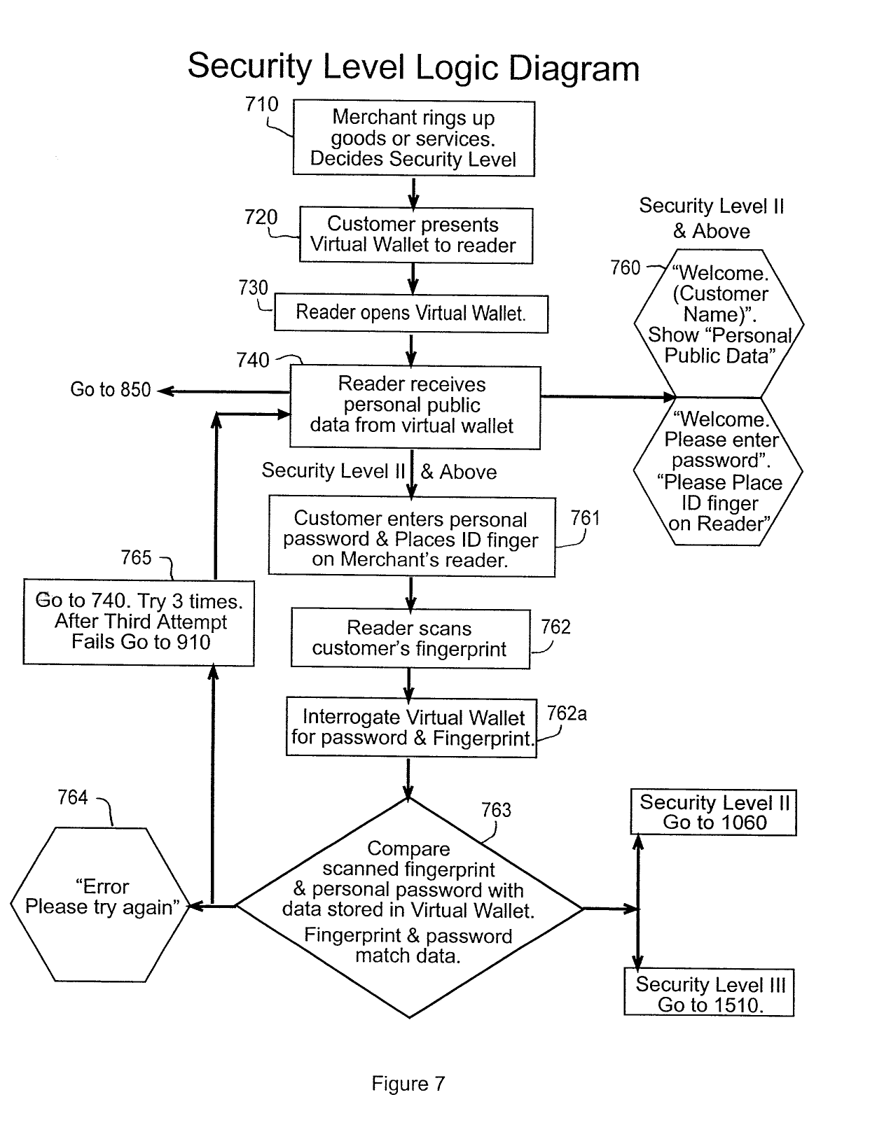

In the event the identity of the owner or accessing computer cannot be verified a number of administrative steps can be taken. As described in FIG. 7, security level I includes the personal public data (e.g., name, phone number, address, photo id, etc.). The data may also be verified by human interaction, e.g., looking at the customer's face, asking the customer his address or other personal public data. In addition, the data may be verified by contacting the remote processing unit's database 540 to confirm whether the personal public data shown in the display of the remote device 520 matches with that stored in the remote database 540. Security level I is the lowest level of protection available in the process of identification authentication. Thus, none of the forms of payment contained in the miniaturized computer can be used with security level I. Security level II includes the biometric identification criteria and password to gain access to the forms of payment contained in the miniaturized computer. Security level III includes all the level of protection provided in security level II with the addition of verification of the personal public data, biometric identification criteria and password with the remote database.

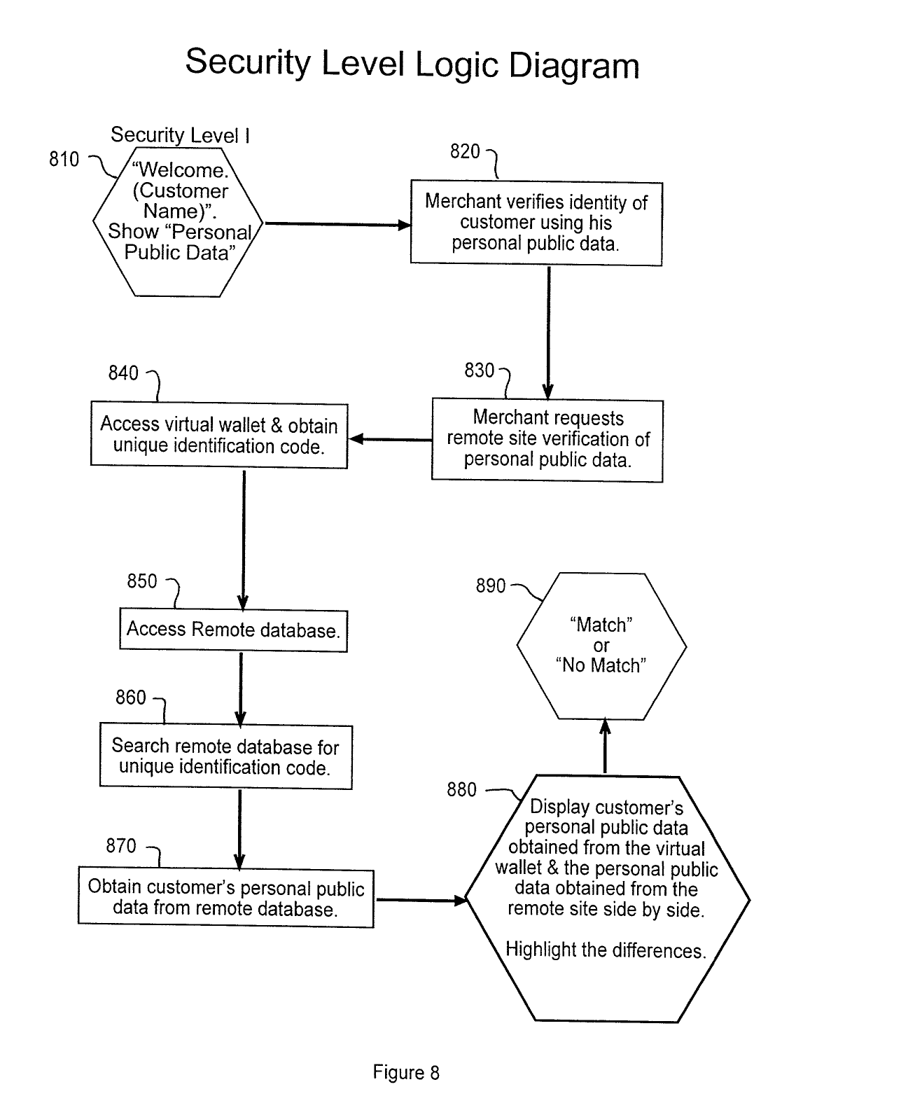

FIGS. 7 and 8 described the use of multiple security levels. By way of example, as described in the second embodiment of the invention, after a merchant calculates the cost of the goods/services to be purchased and the merchant determines the security level based on the cost of goods 710. For example, when buying a $30 radio, the merchant may only require security level II. On the other hand, when buying a $3000 computer, the merchant may require security level III. At least three security levels are utilized in the process of identification authentication in accordance with an embodiment of the present invention.

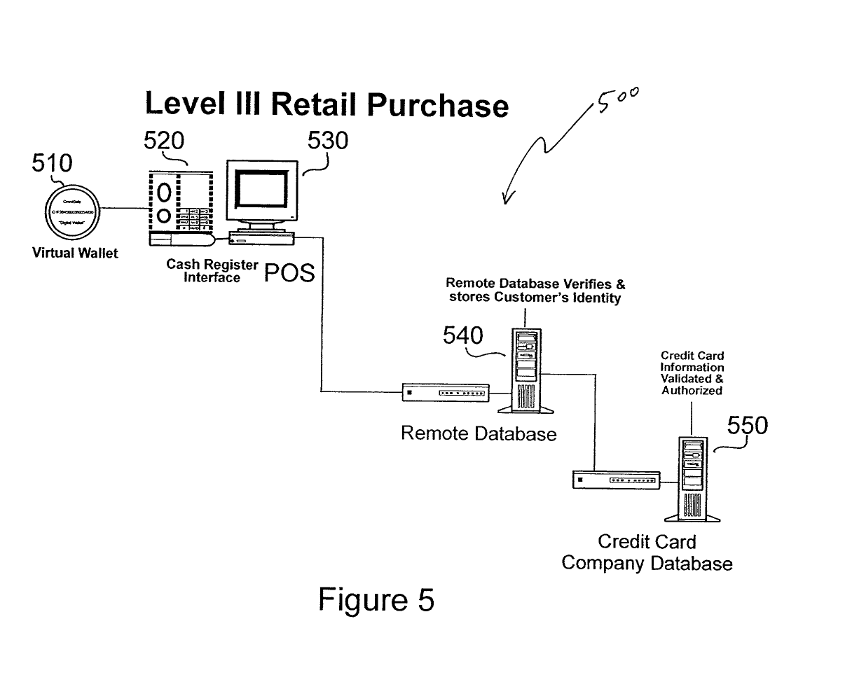

A second embodiment of the present invention is used in retail purchases. As shown in FIG. 5, an identification authentication system 500 having a portable miniaturized computer 510, a remote device 520, a point of sale device 530, a remote database 540, and a credit card company database 550 is provided. The portable miniaturized computer 510 is capable of being read and scanned by the remote device 520 communicably linked to the interface of the miniaturized computer. The remote device 520 is also communicably linked to the point of sale device 530 via a docking port, hardwired, wireless or any other communications means that would facilitate the communication between remote device 520 and the point of sale device 530.

The point of sale device 530 records all transactions performed between the merchant and the customer. Furthermore, the point of sale device 530 determines the value of the transactions. It also transmits the transactions and receives payment information via the remote device 520. The point of sale device 530 can be a computerized cash register or other devices that would record point of sale transactions. The point of sale device 530 is communicably linked with the remote processing unit's database 540. The link can be either by modem, hardwired, wireless or any other communications means that would facilitate the communication between the point of sale device 530 and the remote processing unit's database 540. The remote processing's unit database 540 contains the customer's personal public data, selected password, and selected biometric identification criteria. This information is accessed and used to verify the identity of the customer.

The point of sale device 530 is further communicably linked with the credit card company database 550. The link can be either by hardwired, wireless or any other communications means that would facilitate the communication between the point of sale device 530 and the credit card company database 550. This link is used to confirm credit availability, expiration date and other credit card requirements.

In response to the merchant's request for payment, the customer presents his miniaturized computer/virtual wallet 510 to a remote device 520 as shown in FIG. 5 as step 720. The remote device 520 then opens the miniaturized computer 510. Upon successful opening of the miniaturized computer 510, the remote device 520 retrieves the personal public data from the miniaturized computer 510 as shown as 740.

As described in FIG. 8, if Security Level I is selected, the remote device 520 will display the customer's personal public data (Step 880). Personal public data may be verified. The data may be verified by human interaction, e.g., looking at the customer's face, asking the customer his address or other personal public data. In addition, the data may be verified by contacting the remote database 540 to confirm whether the personal public data shown in the display of the remote device 520 matches with that stored in the remote processing unit database 540 (step 830). The remote device 520 obtains the unique identifier code of the miniaturized computer 510, followed by the remote device 520 accessing the remote database 540 (step 850). The reader 520 displays both the personal public data from the remote database 540 and the personal public data from the miniaturized computer 510 side by side (step 880). The differences between the two personal public data may be highlighted to assist the merchant in his verification process. The reader further displays “MATCH” when the two personal public data matches and “NO MATCH” when they disagree (step 890). At this time, the merchant has the discretion to deny or accept the purchase transaction.

If Security Level II or above is selected, the reader will display the personal public data and prompts entry of a password and the previously selected biometric identification criteria as described in FIG. 7. In response to the prompts, the password and selected biometric identification criteria, e.g., fingerprint is entered. Once the password and the selected biometric identification criteria is entered, the remote device 520 scans the selected biometric identification criteria 762. The remote device 520 compares the password and the biometric identification data stored in the computer wallet 510.

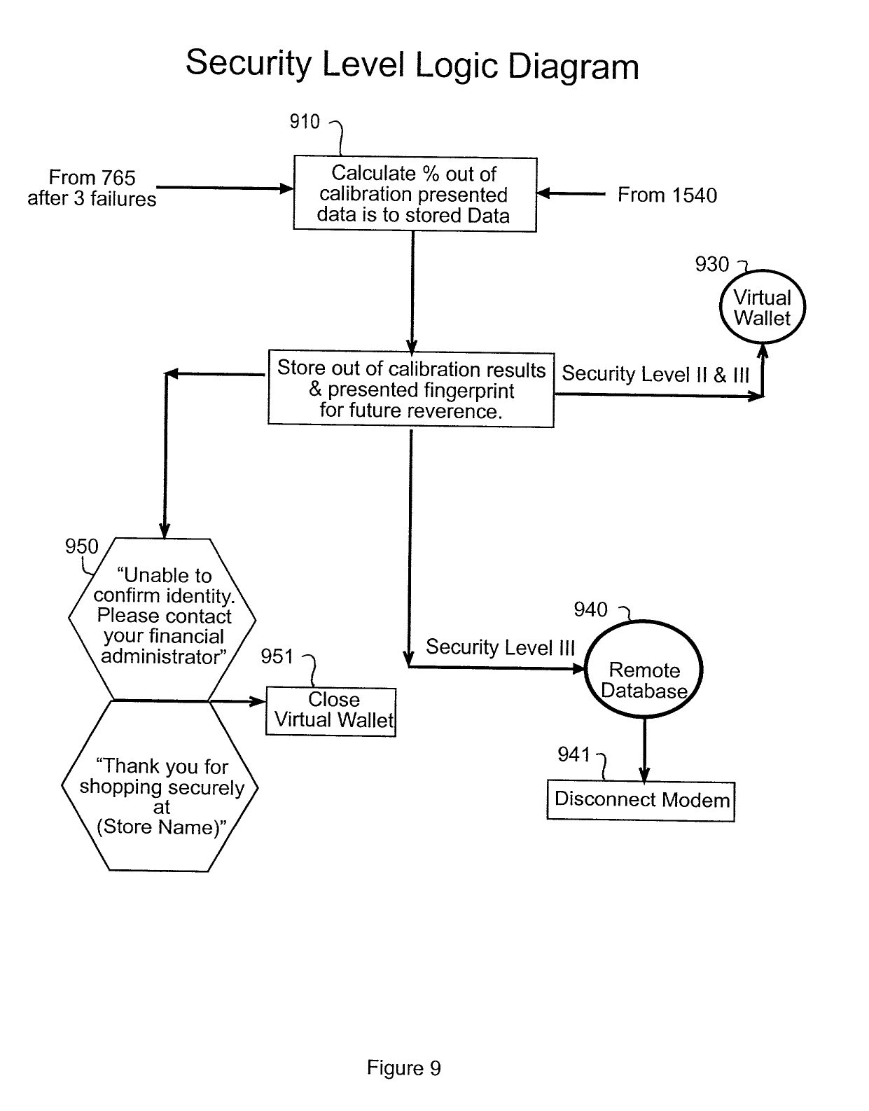

If the two sets of data do not match, the reader 520 will display “ERROR, PLEASE TRY AGAIN” and are then repeated three times as shown in FIG. 7. This step allows three attempts to enter the correct biometric identification criteria and the correct password. As described in FIG. 9, after three failures, the percentage of error in the biometric identification criteria provided may be calculated, i.e. the extent to which the entered data is out of calibration as compared to the stored data. The out of calibration results and the biometric identification criteria provided are then stored as shown in FIG. 9. The out of calibration results and the biometric identification criteria may also be stored in the remote database 540. The calibration results can be used to inform the customer to reenter his biometric identification criteria if the previously stored biometric identification criteria has changed over time. The results may also be used to keep records of the biometric identification criteria that is in error. Such records would be helpful as evidence in a criminal proceeding. Simultaneously, as described in FIG. 9, the reader 520 may display “UNABLE TO CONFIRM IDENTITY. PLEASE CONTACT YOUR FINANCIAL ADMINISTRATOR. THANK YOU FOR SHOPPING AT (STORE NAME)”. The remote device 520 then closes the miniaturized computer.

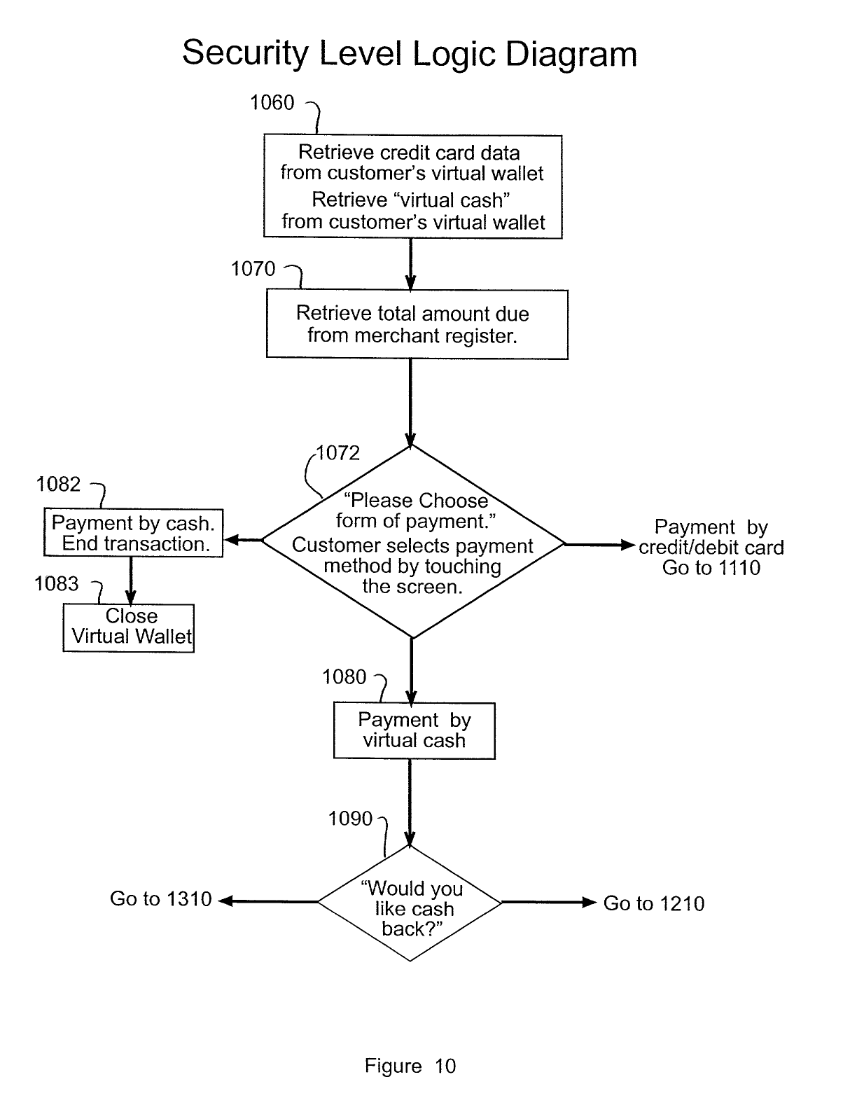

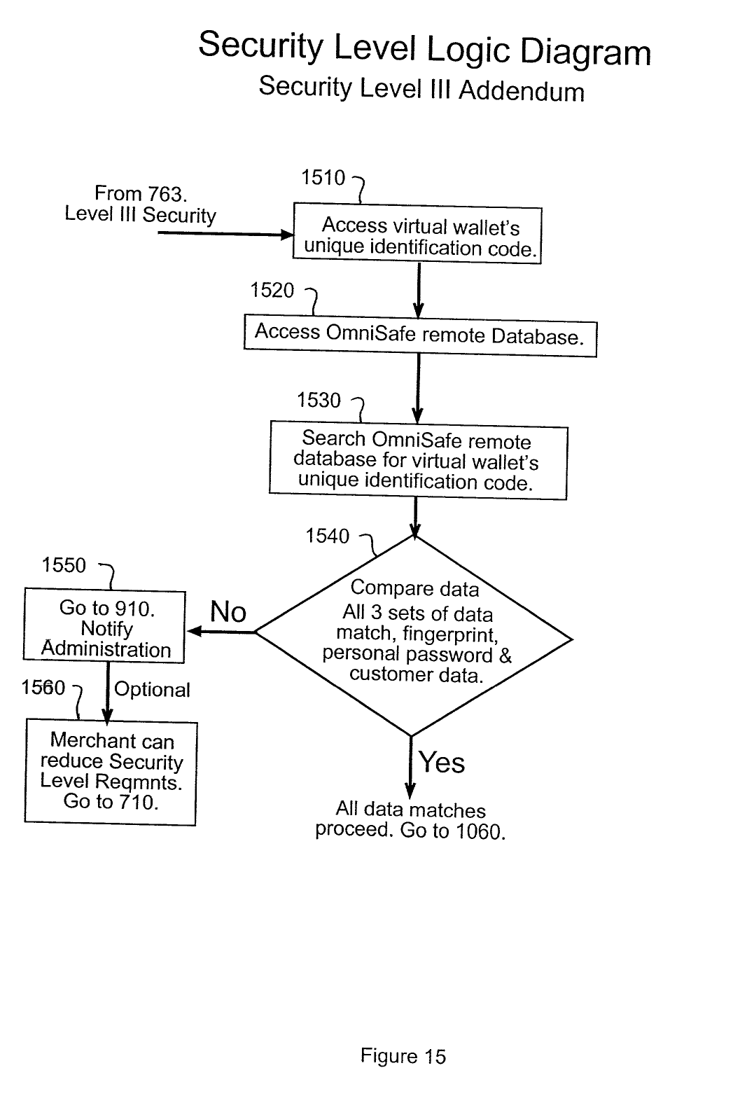

As described in FIG. 15, if the merchant has selected security level III or above, the system 500 will retrieve the unique identifier code of the miniaturized computer 510. Subsequently, the system 500 uses the unique identifier code to access the same unique identifier code stored in the remote database 540 and accesses the customer's file. The file may contain the personal public data, biometric identification criteria and a password. The scanned biometric identification criteria and the entered password will then be compared to the biometric identification criteria and password stored in the remote database 540. If the two sets of data match, then the transaction proceeds as shown in FIG. 10. If the two sets of data do not match, then step 910 of FIG. 9 is repeated and the remote device 520 will prompt “NOTIFY ADMINISTRATION”. Alternatively, the merchant may reduce the security level so as to allow the customer to use the miniaturized computer 510 to complete the transaction.

Subsequently, as described in FIG. 10, the remote device 520 retrieves the total amount due to the merchant from the point of sale device 530. Also as taught in FIG. 10, the remote device 520 prompts the customer with “PLEASE CHOOSE FORM OF PAYMENT” and displays the available forms of payment stored in the miniaturized computer 510. The screen 340 is shown in FIG. 3. All of the available forms of payment stored in the miniaturized computer 510 may be displayed, including the virtual cash data, even if it is $0. The screen 340 may also display “REAL CASH” as an option of payment. If certain forms of payment are not accepted, the remote device 520 will only display those forms of payment accepted by the merchant. Upon seeing the prompts on the remote device 520, one of the displayed forms of payment may be selected. By touching the selection option displayed on the screen 340 of the remote device 520, a selection is made. As described in FIG. 3, if payment is to be made by cash, the “REAL CASH” option on the screen 340 is selected. The remote device 520 closes the miniaturized computer 510.

As also described in FIG. 10, if virtual cash as the form of payment is selected, “VIRTUAL CASH” will be displayed on the remote device 520. The remote device 520 then prompts “WOULD YOU LIKE CASH BACK?” If the customer enters an amount as cash back on the remote device 520, that amount will be transferred to the point of sale device 530 and added to total amount due.

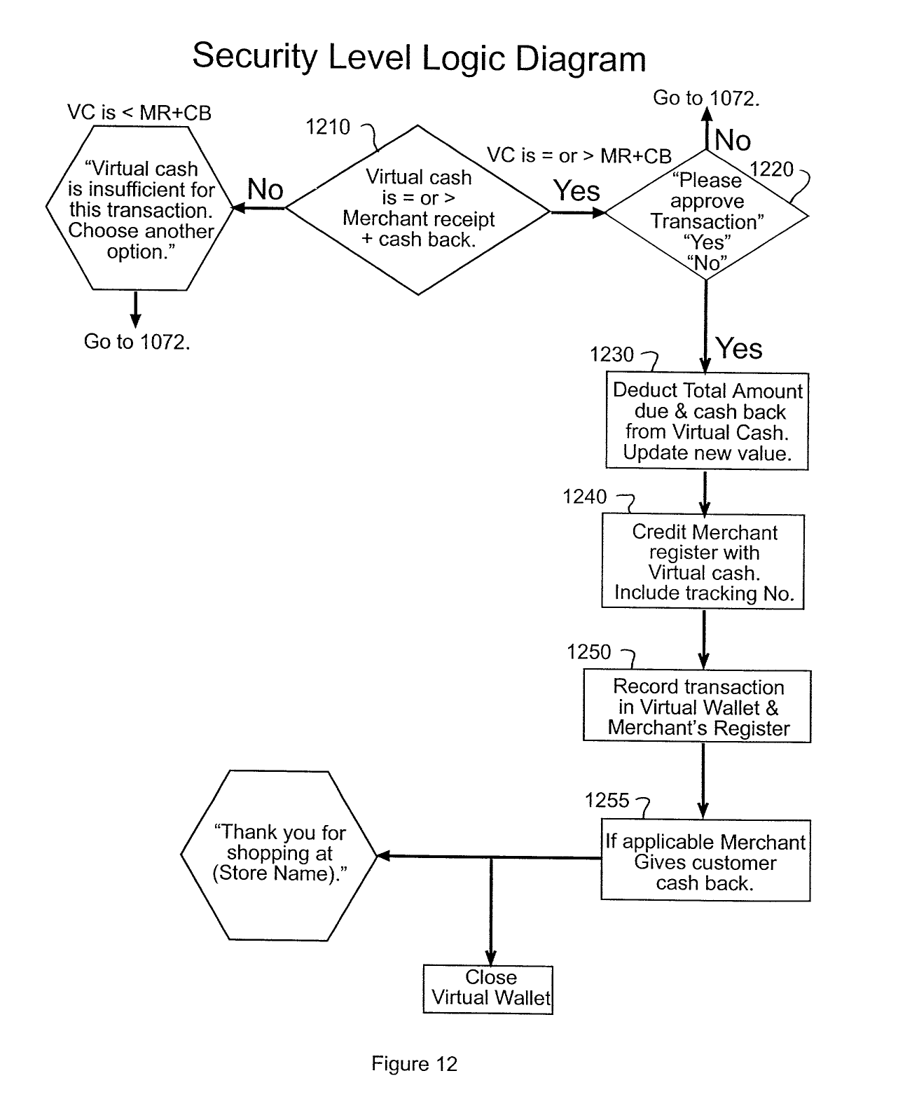

Subsequently, whether the virtual cash amount is greater than or equal to the total amount due, including the amount of cash back, is determined. If the virtual cash amount is greater than or equal to the total amount due, including the amount of cash back, then the remote device 520 will prompt “PLEASE APPROVE TRANSACTION? YES OR NO”. If the transaction is not approved, “PLEASE CHOOSE FORM OF PAYMENT” will be asked again. On the other hand, if the transaction is approved, the total amount due, including cash back, will be deducted from the virtual cash amount, and the virtual cash amount will be updated as shown in FIG. 12. The merchant is credited with the total amount due and is provided with a tracking number as also shown in FIG. 12. Subsequently thereafter, the remote device 520 stores the record of the financial transaction into the miniaturized computer 510 and the point of sale device (FIG. 12). A paper copy of this financial transaction may be provided. Afterwards, the merchant provides the customer with the amount of cash back. The remote device 520 closes the computer 510 and displays “THANK YOU FOR SHOPPING AT (STORE'S NAME)”. If the virtual cash amount is less than the total amount due, including the amount of cash back, then the form of payment steps must be repeated beginning with “Please Choose Form of Payment” as shown in FIG. 10.

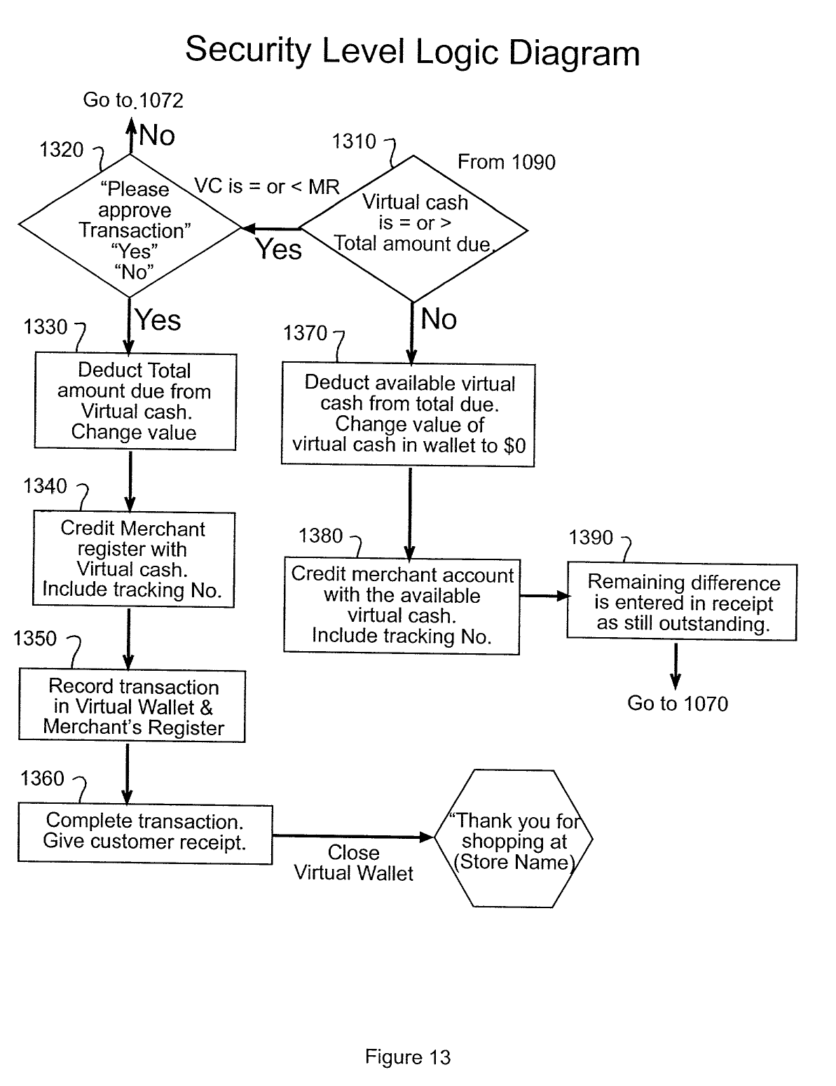

If no cash back is entered by the customer, whether the cash amount is greater than or equal to the total amount due will be determined as shown in FIG. 13. If the virtual cash amount is greater than or equal to the total amount due, then the remote device 520 will prompt “PLEASE APPROVE TRANSACTION? YES OR NO”. If the transaction is disapproved, the steps must be repeated. If the transaction is approved, the total amount due will be deducted from the cash amount and the cash amount will be updated as shown in FIG. 13. The total amount due is credited to seller and is provided with a tracking number. The remote device 520 also stores the record of the financial transaction into the computer 510. The remote device 520 closes the computer 510 and displays “THANK YOU FOR SHOPPING AT (STORE'S NAME).”

As also described in FIG. 13, if the virtual cash amount is less than the total amount due, then the total amount due will be deducted from the virtual cash amount and the virtual cash amount will be updated to zero. The merchant is then credited with the amount paid and is provided with a tracking number and an additional form of payment is requested.

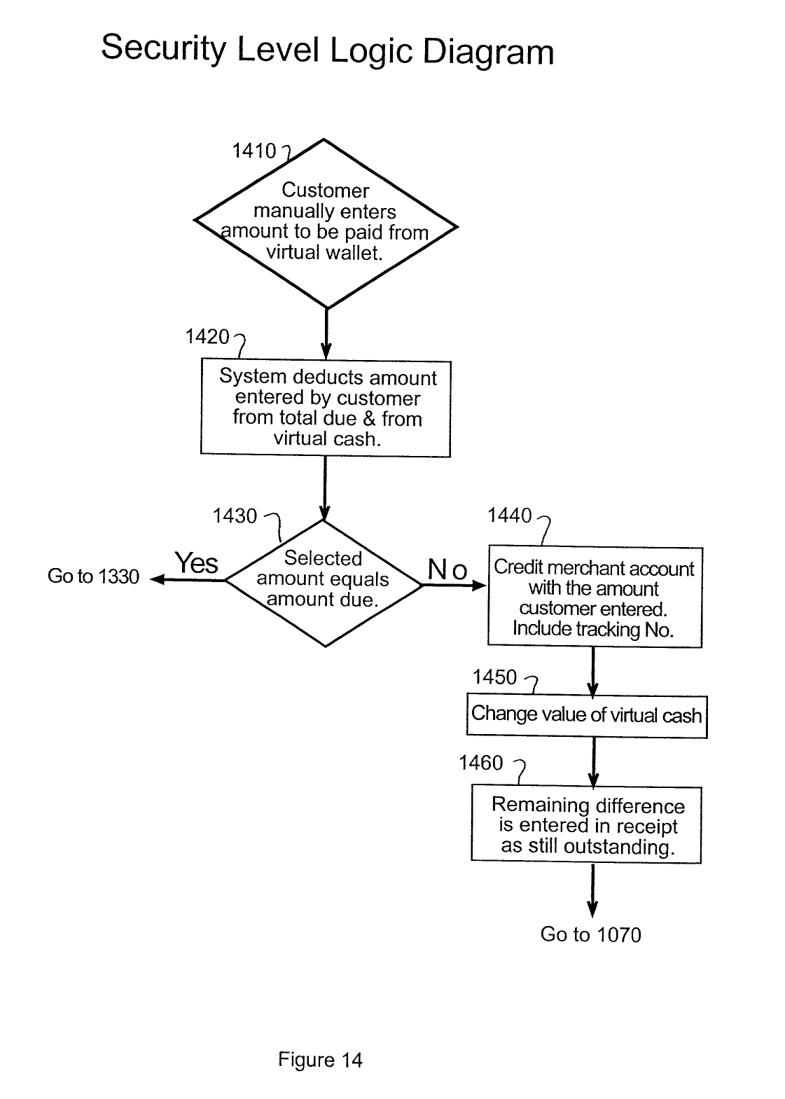

As shown in FIG. 14, if no cash back is entered, the exact amount to be paid from the miniaturized computer 510 is entered. The exact amount entered is then deducted from total amount due. If the exact amount entered equals to the total amount due, transaction approval is repeated as shown in FIG. 13. If the exact amount entered the exact amount entered is subtracted from the total amount due and the virtual cash account is updated to reflect the difference. The merchant is then credited with the amount paid and is provided a tracking number. The remaining amount due is then entered into the receipt and an additional form of payment is requested as in step 1070 FIG. 14.

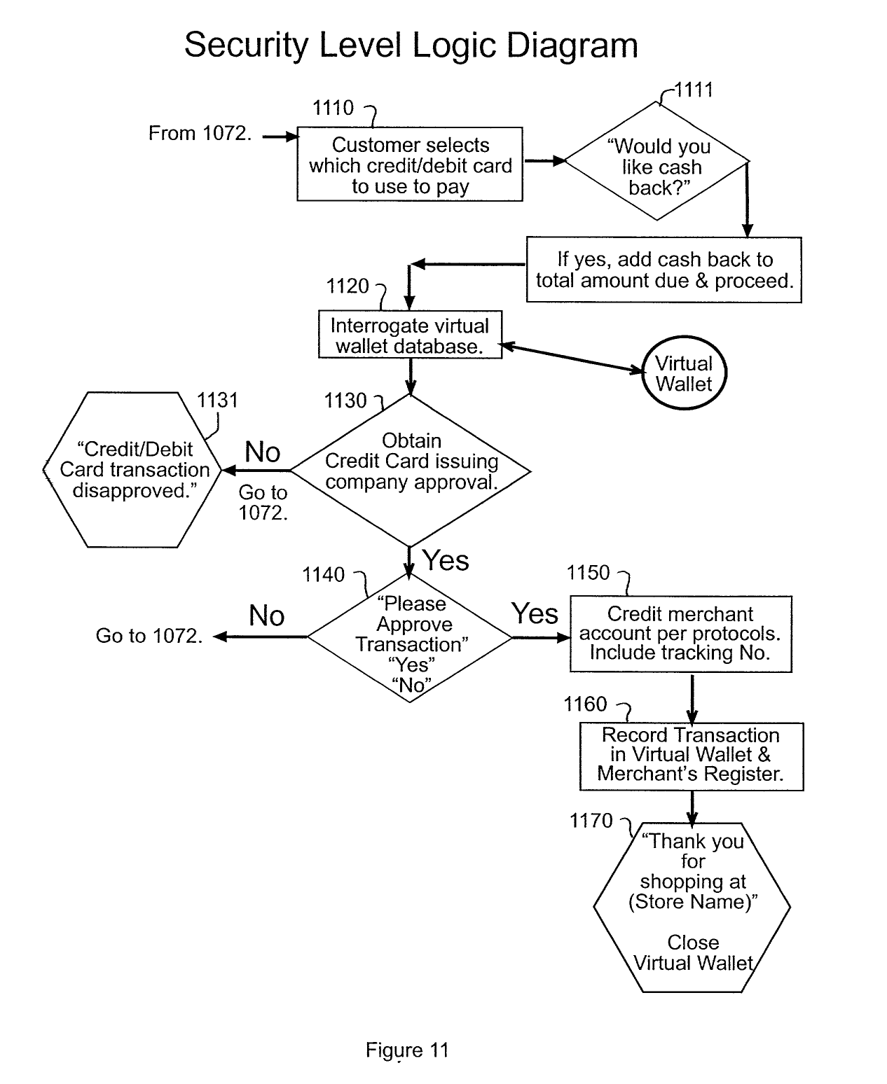

If a particular credit card is used, the type of credit card is selected as described in FIG. 11. The remote device 520 then prompts the customer “WOULD YOU LIKE CASH BACK?” If the customer enters an amount as cash back on the remote device 520, that amount will be transferred to the point of sale device 530 to be added to the total amount due. As also described in FIG. 11, after determining the total amount to be deducted from the particular credit card, the remote device 520 retrieves from the miniaturized computer 510 credit card validation information, such as name, expiration dates, credit card issuer, the issuer's phone number, etc.. The validation information is used to contact the credit card issuer and obtain approval. If no approval is obtained, the remote device 520 will display “CREDIT CARD TRANSACTION DISAPPROVED,” and the process is repeated (FIG. 11). If approval is obtained, the remote device 520 will prompt “PLEASE APPROVE TRANSACTION? YES OR NO”. If the transaction is not approved, these steps will be repeated. On the other hand, if the transaction is approved, the credit card issuer initiates credit payment protocols and credits the merchant with the total amount due and provides the merchant with a tracking number. Subsequently thereafter, the remote device 520 stores the record of the financial transaction into the miniaturized computer 510 and the point of sale device 530. The paper copy of this financial transaction may be provided. Upon completion, the remote device 520 closes the computer 510 and displays “THANK YOU FOR SHOPPING AT (STORE'S NAME)”.

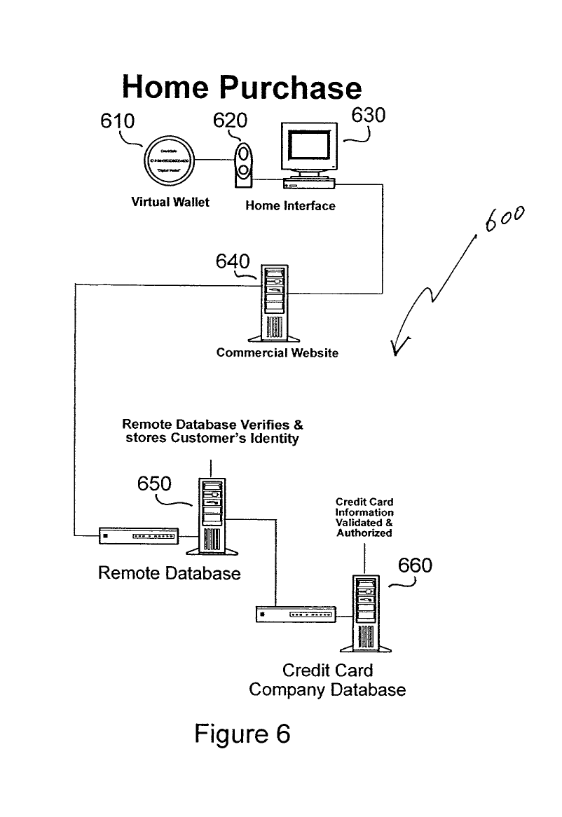

FIG. 6 illustrates the third embodiment of the present invention. An identification authentication system 600 is used in a home purchase environment over the Internet. The identification authentication system 600 includes a portable miniaturized computer 610, a remote device 620, a home computer 630, a point of sale device 640, a remote database 650, and a credit card company database 660. The identification authentication system 600 operates much like the identification authentication system 500, except that the home computer 630 is used to communicate via the Internet to the point of sale device 640, which is typically located off-site in a commercial web site server. The point of sale device 640 is communicably linked with the remote processing unit database 650 and credit card company database 660 as the point of sale device 530 is communicably linked with the remote processing unit database 540 and credit card company database 550.

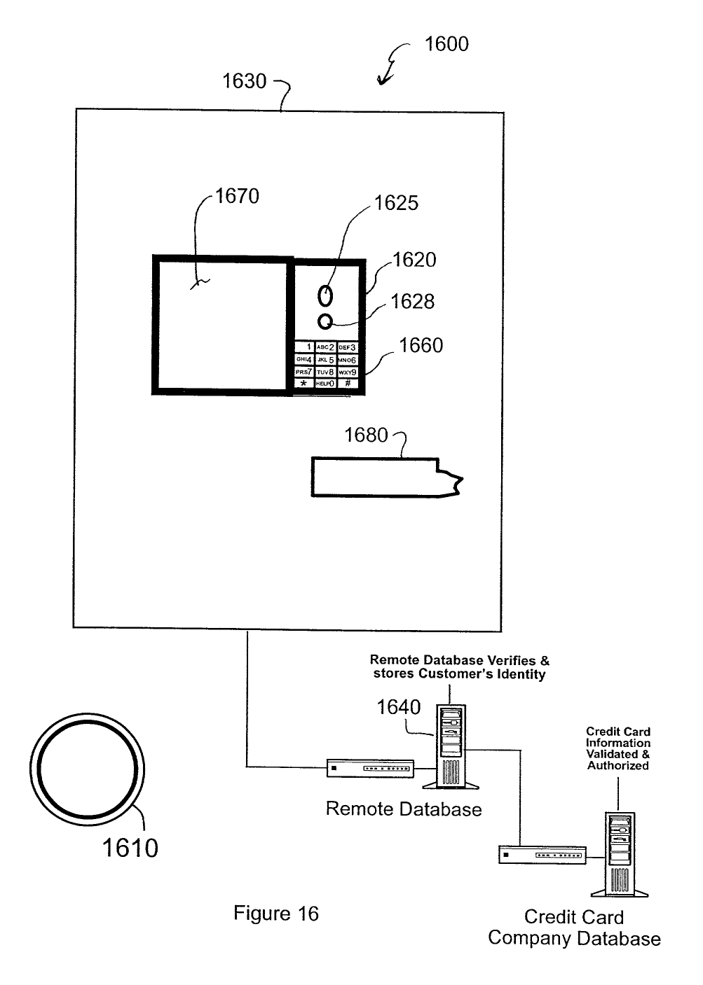

In a fourth embodiment of the subject invention, the present invention may also be used in conjunction with ATMs to receive and transfer real cash and virtual cash. As shown in FIG. 16, an ATM 1630 in accordance with an embodiment of the present invention is illustrated with a remote device 1620 having a second processor, a keyboard 1660, a screen 1670 and a cash drawer 1680. The remote device 1620 includes a biometric scanner 1625 and a data access port 1628. In this embodiment, the remote device 1620 is used in conjunction with a miniaturized computer 1610 to perform financial transactions at the ATM 1630. Each bank can choose the security level it wants to use, e.g., security level IIl.

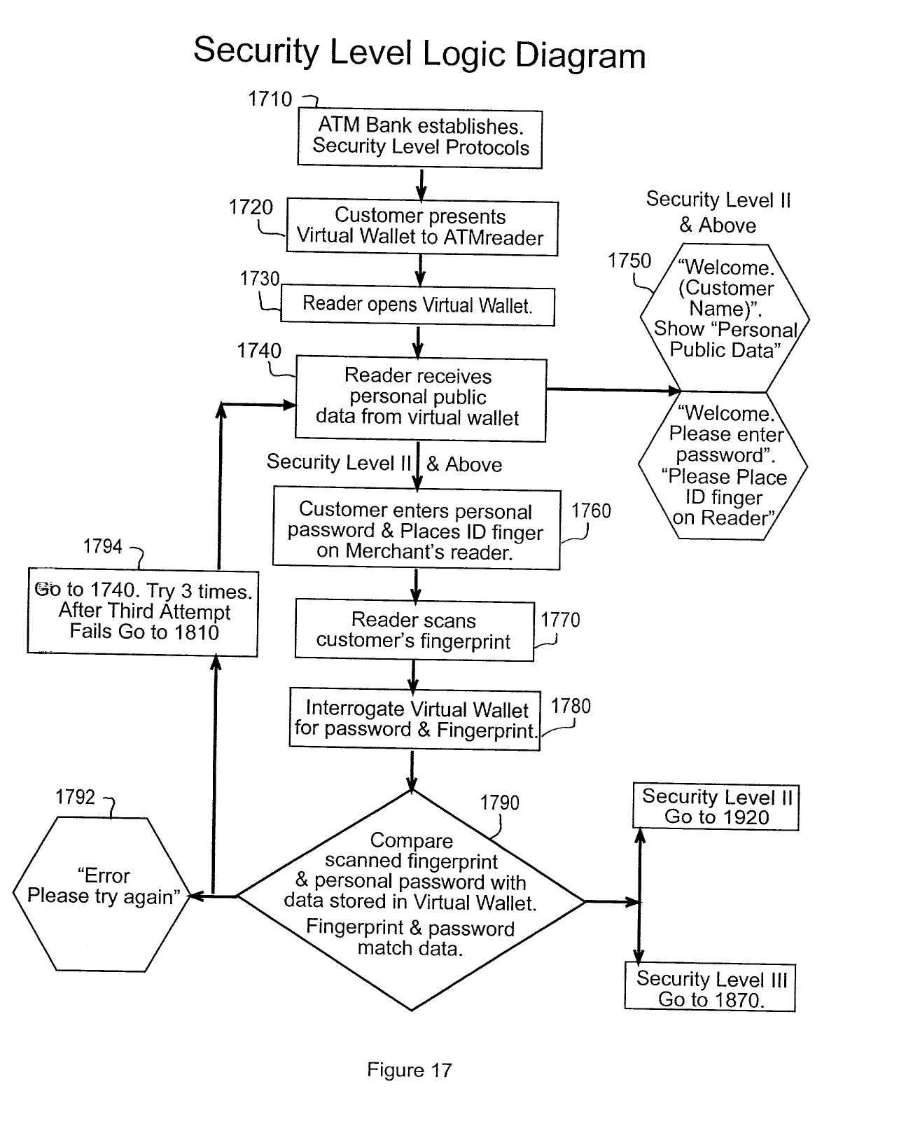

As described in FIG. 17, the miniaturized computer 1610 is used to perform financial transactions at the ATM 1630. First, the bank establishes the particular security level it wants to use on the ATM 1630. The bank may choose any security level it desires. However, security level II or higher is recommended for financial transactions. To make a financial transaction at the ATM 1630, the miniaturized computer 1610 is placed in the data access port 1628. In response, the remote device 1620 opens the miniaturized computer 1610 as described in FIG. 17. Once the miniaturized computer 1610 is opened, the remote device 1620 retrieves the personal public data from the miniaturized computer 1610.

If the bank has selected security level II or above described above, the remote device will display the customer's personal public data and prompts the entry of a password and the previously selected biometric identification criteria as described in FIG. 17. In response to the prompts, the password is entered along with the selected biometric identification criteria, e.g., fingerprint.

As further described in FIG. 17, when the selected biometric identification criteria is provided, the remote device 1620 scans the selected biometric identification criteria. The remote device 1620 asks the miniaturized computer 1610 for the password and the biometric identification data stored in the wallet 1610. Then, the scanned biometric identification criteria and the entered password are compared by the second processor with the remote device 520 with the biometric identification criteria and password stored in the miniaturized computer 1610. All of these steps may occur simultaneously. If the two sets of data do not match, the remote device 1620 will display “ERROR, PLEASE TRY AGAIN” as also described in FIG. 17 and the identification steps may be repeated three times.

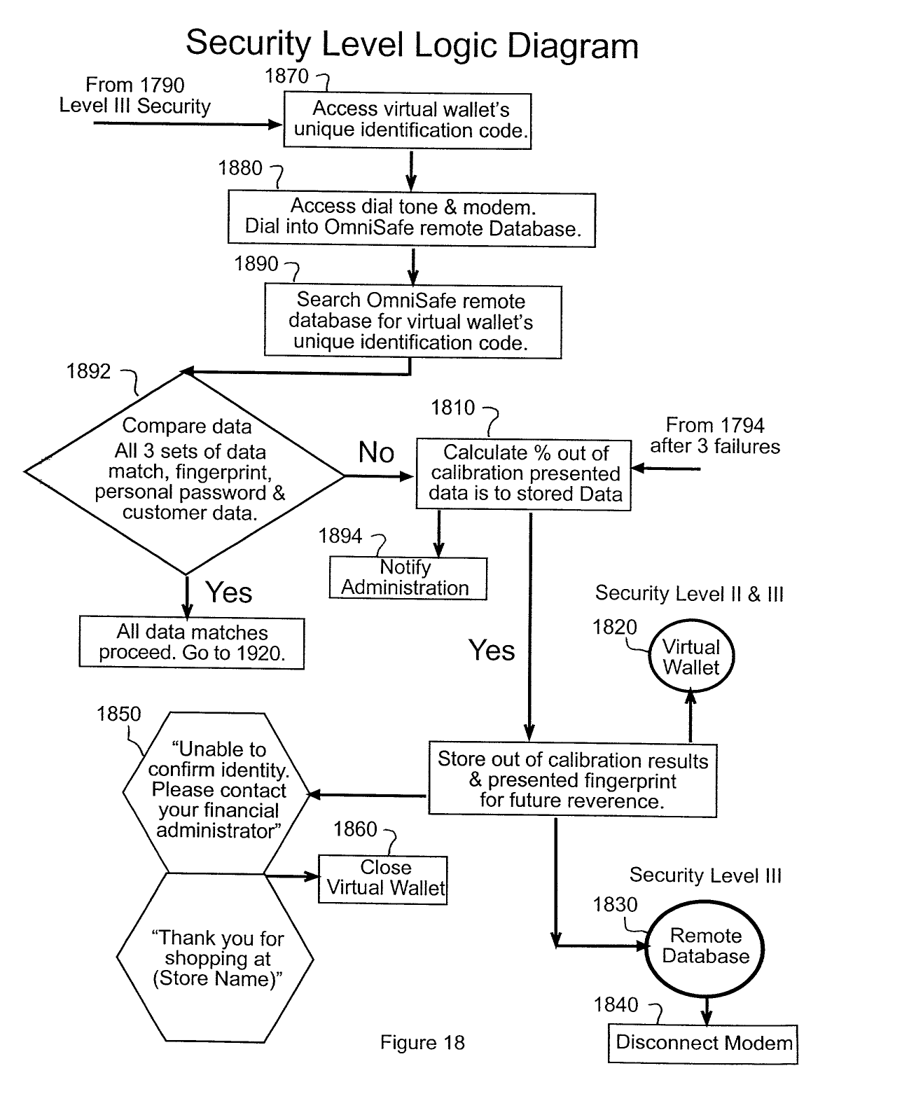

As described in FIG. 18, after the third attempt fails, the percentage of error in the biometric identification criteria provided is calculated, i.e. the extent to which the entered data is out of calibration as compared to the stored data in the miniaturized computer 1610 or the remote processing unit database 1640 is measured. The out of calibration results and the biometric identification criteria provided are then stored in the miniaturized computer 1610 for security level II or above. The out of calibration results and the biometric identification criteria provided may further be stored in the remote database 1640 for security level III or above. The calibration results can be used to inform the customer to reenter his biometric identification criteria if the previously stored biometric identification criteria has changed over time. The results may also be used to keep records of the biometric identification criteria that is in error. Such records would be helpful as evidence in a criminal proceeding. Once access is denied, the modem to access the remote database 1640 is disconnected. Simultaneously, the remote device 1620 displays “UNABLE TO CONFIRM IDENTITY. PLEASE CONTACT YOUR FINANCIAL ADMINISTRATOR. THANK YOU FOR SHOPPING AT (STORE NAME)”. The remote device 1620 then closes the miniaturized computer 1610. If the two sets of data match, then the ATM 1630 displays several transaction options on the screen 1670.

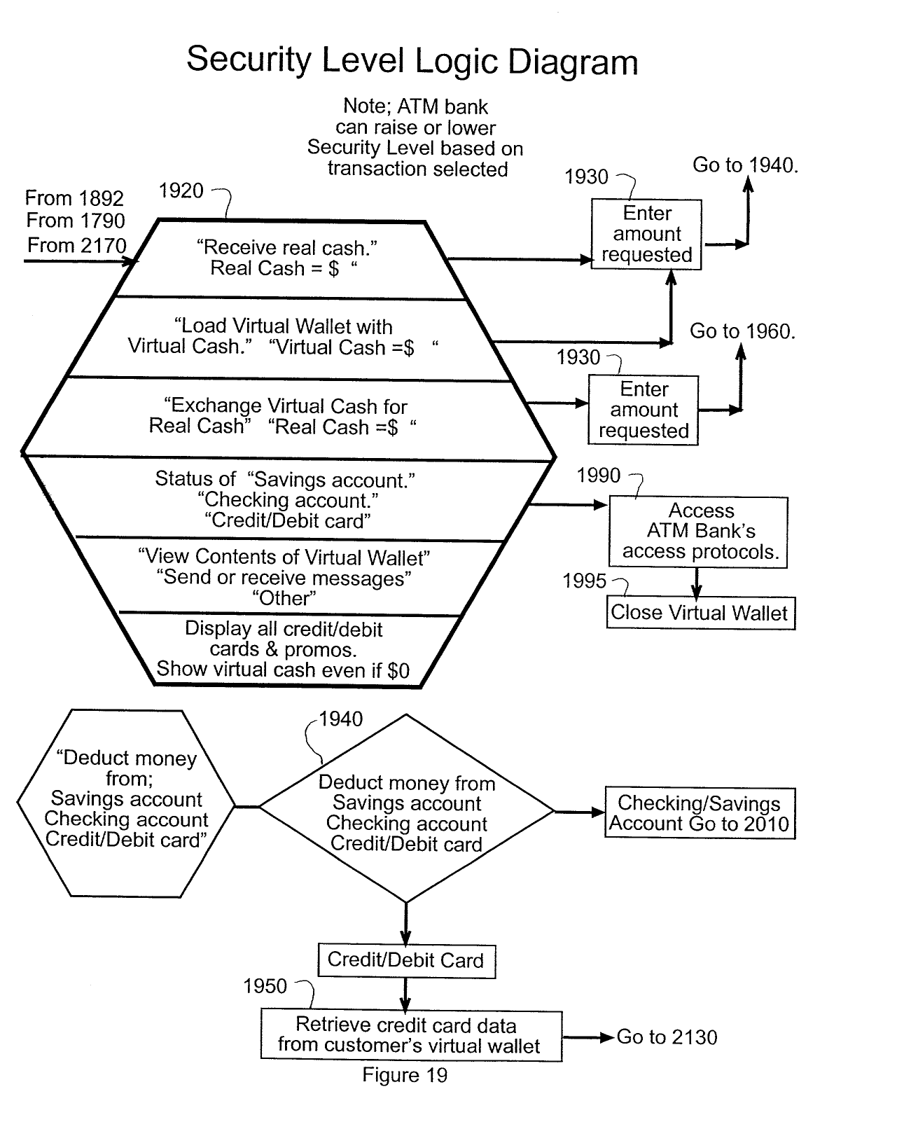

As described in FIG. 19, multiple type of inquiries are available 1920. If “RECEIVE REAL CASH” is selected, the screen 1670 will further prompt the customer “ENTER AMOUNT REQUESTED”. The ATM 1630 then further prompts the customer “DEDUCT MONEY FROM: SAVINGS ACCOUNT, CHECKING ACCOUNT, CREDIT/DEBIT CARD.”

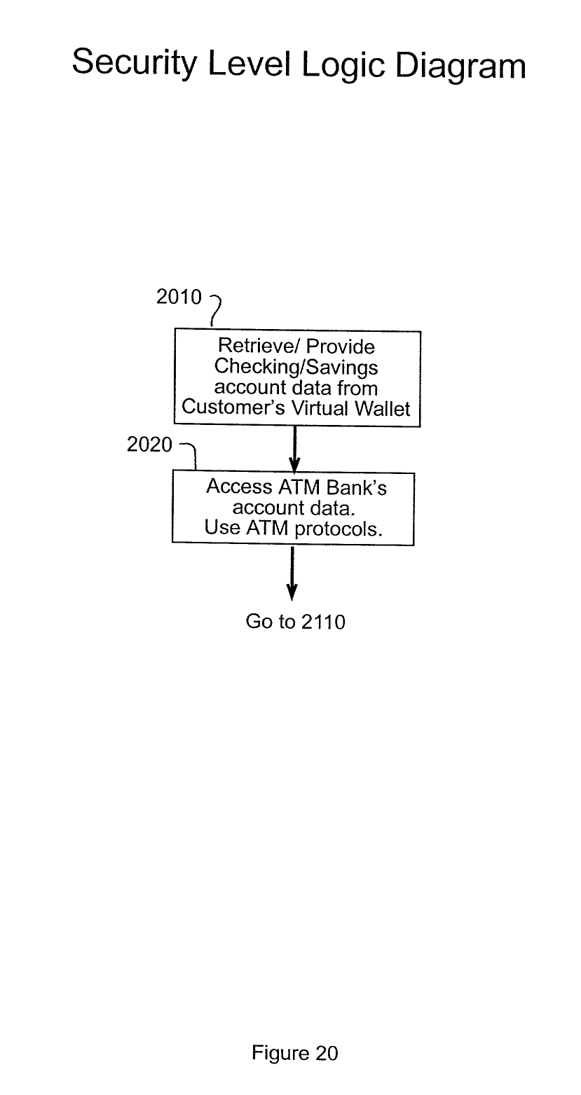

As described in FIG. 20, if money is to be deducted from his checking or savings account, then the remote device 1620 retrieves the checking or savings account data from the miniaturized computer 1610 and provides this information to the ATM 1630. The ATM 1630 then utilizes standard protocols to access and transfer the funds from the customer's account to the ATM 1630. The standard protocols the ATM uses to transfer funds are well known in the art and are useful for use in connection with the present invention. The ATM 1630 will then issue real cash from the ATM's cash drawer 1680.

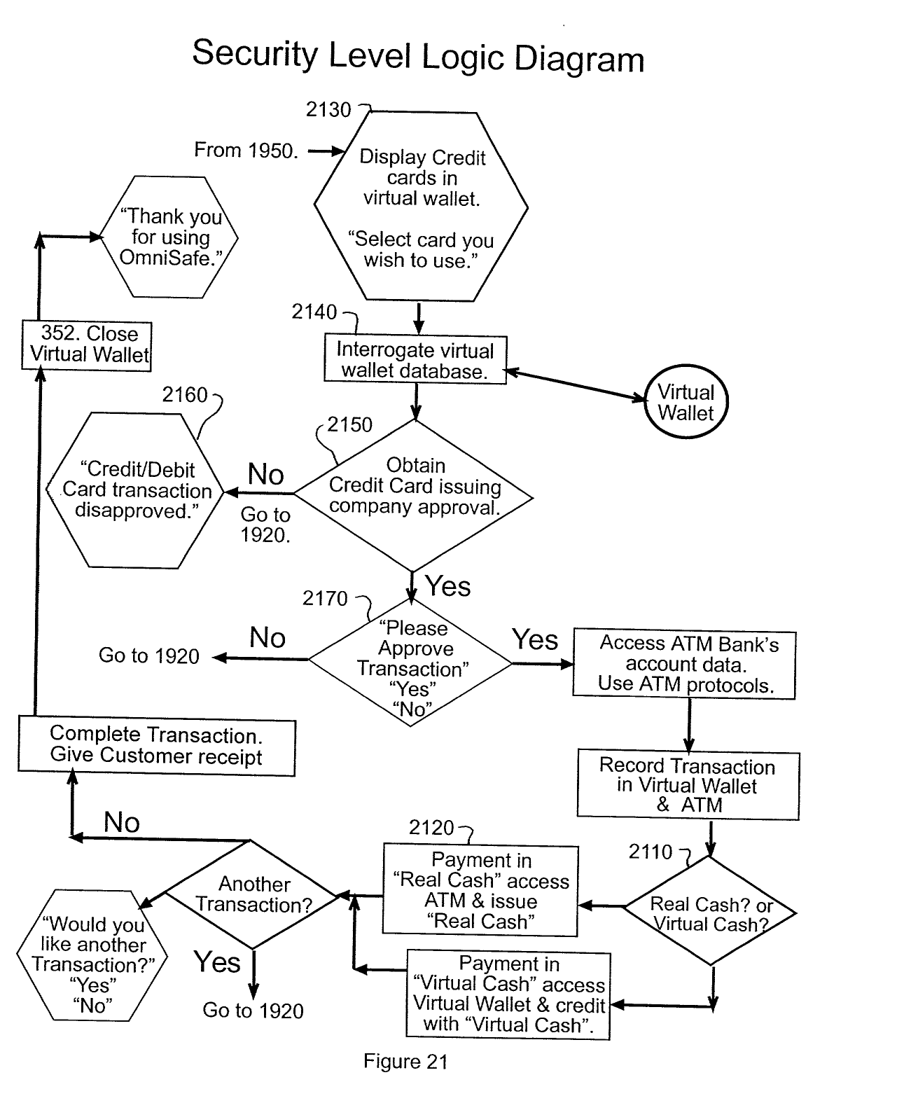

As described in FIG. 21, if money is deducted from a credit/debit card account, then the remote device 1620 retrieves the customer's credit/debit card account data from the computer 1610 and provides this information to the ATM 1630. The ATM 1630 then displays all the credit card accounts that are stored in the miniaturized computer 1610 and prompts the customer “SELECT CARD YOU WISH TO USE.” After selecting the particular credit card, the remote device 1620 prompts the computer 1610 to obtain that credit card validation information, such as name, expiration dates, credit card issuer, the issuer's phone number, etc. The validation information is used to contact the credit card issuer and obtains approval. If no approval is obtained, the remote device 1620 will display “CREDIT CARD TRANSACTION DISAPPROVED”, and the process is repeated. If approval is obtained, the remote device 1620 will prompt “PLEASE APPROVE TRANSACTION? YES OR NO”. If the customer disapproves the transaction, then the type of transaction inquiry will be repeated as described in FIG. 19. On the other hand, if the customer approves the transaction, the credit card issuer initiates credit payment protocols and credits the ATM 1630 with the entered amount requested and provides the ATM 1630 with a tracking number. Subsequently thereafter, the remote device 1620 stores the record of the financial transaction into the miniaturized computer 1610 and the ATM 1630. The ATM 1630 may provide a paper copy of this financial transaction to the customer.

As also described in FIG. 19, if the customer selects “LOAD VIRTUAL WALLET WITH VIRTUAL CASH,” the screen 1670 will further prompt the customer “ENTER AMOUNT REQUESTED”. All the steps for this option is the same as the steps for the “RECEIVE REAL CASH” option. The only difference is that here the customer is dealing with virtual cash, rather than real cash. Thus, the ATM 1630 accesses the miniaturized computer 1610 through the remote device 1620 and increases the value of virtual cash stored in the miniaturized computer 1610 by the entered amount requested.

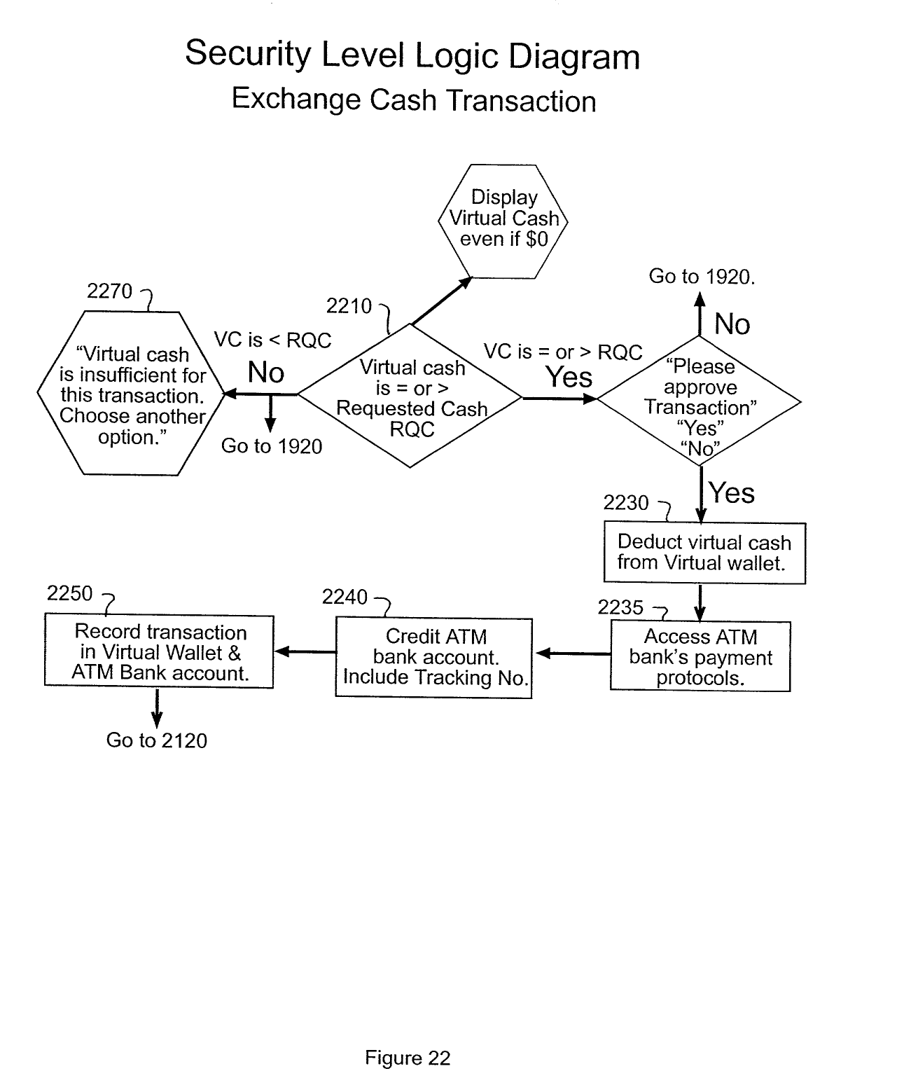

If the “EXCHANGE VIRTUAL CASH FOR REAL CASH” is selected, the screen 1670 will further prompt the customer “ENTER AMOUNT REQUESTED”. The ATM 1630 then retrieves the available virtual cash amount from the miniaturized computer 1610 through the remote device 1620. As described in FIG. 22, the system determines whether the available virtual cash amount is greater than or equal to the entered amount requested. If the available virtual cash amount is greater than or equal to the entered amount requested, then the remote device 1620 will prompt “PLEASE APPROVE TRANSACTION? YES OR NO” (FIG. 22). If the customer disapproves the transaction, the type of transaction inquiry 1920 is repeated. On the other hand, if the customer approves the transaction, the entered amount requested, will be deducted from the available virtual cash amount, and the available virtual cash amount will be updated. The ATM 1630 then utilizes standard protocols to access and transfer the funds from the customer's virtual cash to the ATM 1630. The ATM 1630 is thereafter credited with the entered amount requested and is provided with a tracking number. The remote device 1620 then stores the record of the financial transaction into the miniaturized computer 1610 and the ATM 1630. The ATM 1630 will then issue real cash from the ATM's cash drawer 1680 (FIG. 21). If the available virtual cash amount is less than to the entered amount requested, then the type of transaction inquiry 1920 is repeated.

As described in FIGS. 17 and 18, if the two sets of data match, and if the merchant has selected security level III or above, the system 1600 will retrieve the unique identifier code of the miniaturized computer 1610. The system 1600 then accesses the remote processing unit database 540. Subsequently, the system 1600 uses the unique identifier code to locate the same unique identifier code stored in the remote database 1640 and accesses the customer's file. The file may contain the customer's personal public data, his biometric identification criteria and password. The scanned biometric identification criteria and the entered password will then be compared to the biometric identification criteria and password stored in the remote processing unit database 1640 as described in FIG. 18. If the two sets of data match, then the type of transaction inquiry 1920 is repeated. If the two sets of data do not match, the remote device 1620 will prompt “NOTIFY ADMINISTRATION” and the step of authenticating must be repeated.

As described in FIG. 19, if the customer selects “STATUS OF SAVINGS ACCOUNT, CHECKING ACCOUNT OR CREDIT/DEBIT ACCOUNTS,” the option to select which account is provided. Subsequently, the ATM 1630 retrieves the selected account data from the miniaturized computer 1610 through the remote device 1620. The ATM 1630 utilizes standard protocols to access the selected account and display the status requested. After viewing the status of the selected account, the remote device 1620 closes the miniaturized computer 1610.

The present invention may also be used for other ancillary services, such as phone cards, business cards, messaging, reminders, files storage, and copyrighted material protection. These are some examples of the applications that can be used with the present invention.

In a fifth embodiment of the subject invention, the system of the subject invention may also be used for other ancillary services. For example, the miniaturized computer can contain a telephone company's phone card, such as, billing phone number, calling card number, and phone company billing information.

The phone card contained within the miniaturized computer is utilized like the credit card function described above. When a phone card is used to make a phone call, a telephone set must be equipped with a remote device that includes a second processor, a biometric scanner and a data access port for communicating with the miniaturized computer and the miniaturized computer is placed on the data access port. Depending on the security level that is set by the phone company, the terminal would prompt him to enter his password and his biometric identification criteria, e.g., fingerprint, on the scanner. The authentication process used here is similar to that used for accessing credit cards or virtual cash, e.g., security level II or above as discussed above.

When the customer's identity is authenticated, the payphone terminal accesses the phone card's information contained within the miniaturized computer, e.g., account number. The phone terminal prompts the customer to enter the number to be called. Using the standard protocols for making a phone call, the phone call is completed and billed to the telephone company's phone card. Payment for the call can also be through the forms of payments available in the miniaturized computer, such as credit cards, virtual cash.

Additionally, the miniaturized computer may contain an address book. So, when a customer is ready to make a call, the customer can access the address book contained within his miniaturized computer and automatically select the person to be called. The terminal then accesses that number and completes the call without the customer needing to enter the actual phone number. The address book is communicable with either cellular phone, PC's or other handheld PC's so long as they are equipped with a remote device.

In a sixth embodiment of the subject invention, the miniaturized computer can also act as a storage compartment for other people's business cards, as well as the customer's own business card. The customer can designate a portion of his personal public data to be used as his personal business card. The business card includes information such as name, phone number, email address, company name, etc.

Business cards can be exchanged with others via the remote devices. The remote device used may have one or more data access ports. Each person would touch their wallets to the remote device and choose the exchange business cards option on the remote device. Each miniaturized computer would then exchange the business cards and store them in their miniaturized computers. Alternatively, the data may be transmitted via a wireless transmitter/receiver.

Once the customer has designated the particular information to be used as a business card, that information is stored in the miniaturized computer as a business card. When visiting a merchant, for example, the customer can choose to leave his business card by choosing to leave the business card option from the display on the remote device.

In yet a seventh embodiment of the subject invention, the miniaturized computer is also useful for sending messages to other people. The messages can be coded and encrypted so that only designated persons can read or access the message. Messaging can be accomplished by using the simple email programs and encrypting the program with an encryption code. In addition, the miniaturized computer can send a message utilizing the remote database. In this case, the person would identify the addressee by name and send the message to the remote database. When the addressee touches an access port on any remote device and the remote device accesses the remote database, the addressee would receive a notification of the message. All security level protocols are also available to be used for sending and retrieving the messages.

Because the miniaturized computer is used to purchase items such oil changes and can be used to store medical data, the miniaturized computer can also be used to remind customers of maintenance items or important dates. When the customer touches the miniaturized computer to an access port, he would be reminded through the display of the remote device of important dates or other appointments.

In an eighth embodiment of the subject invention, the miniaturized computer is also useful to store items such as pictures, computerized word files, MP3 files, etc. These files can be accessed publicly or by the security levels protocols as discussed above.

The miniaturized computer with its encryption and security level protocols can provide further protection to copyrighted materials, such as movies, books, music, and pictures. When downloading a file on the Internet from a vendor, the vendor can request that the file be tagged with the customer's fingerprint. That fingerprint is then embedded in that file. Thus, that file would only be accessible, i.e., playable, viewable, readable, etc., when the customer provides his fingerprint to a remote device. The file may further be protected using the security level protocols available with miniaturized computer, such as requiring the use of passwords, or remote database verification.

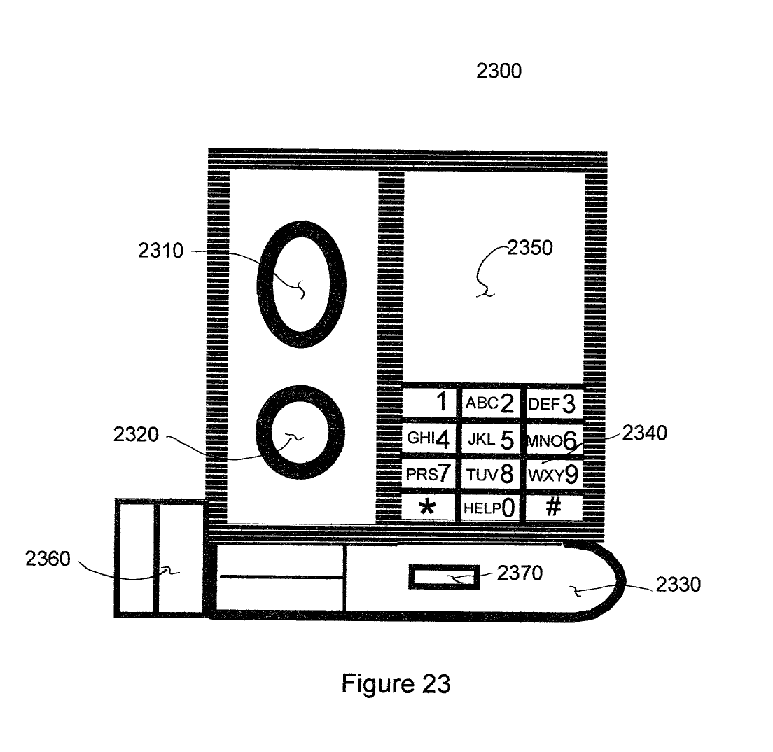

FIG. 23 illustrates an eighth embodiment that includes a magnetic card remote device, capable of reading the coded magnetic strips on the back of credit cards, a smart card remote device capable of reading the embedded computer chip contained in a smart card and virtual wallet interface device 2300. The remote device 2300 has a biometric scanner 2310 and a data touch interface access port 2320. The remote device further includes an interpreter 2330 which is equipped with a USB port 2370. The USB port 2370 allows a person to plug devices into this interface. The biometric scanner 2310 is capable of scanning fingerprints, retina, DNA, face and voice of an individual. The data touch interface access port 2320 is capable of accessing data from the various data fields contained within the miniaturized computer and high density memory of the miniaturized computer 510. The interpreter 2330 includes software and second processor necessary to perform the desired process as is described in this application. The interpreter 2330 begins its process when the computer data is accessed or biometrics is scanned. The interpreter 2330 could be any processor that resides in a device such as a desktop or laptop computer, a hand held PC, a point of sales device (POS), or automated teller machine (ATM). The interpreter 2330 does not have to be separate from the remote device 2300. In one embodiment of the present invention, the interpreter 2300 resides within the remote device 2300.

The interpreter may utilize any one of a wide range of languages and software operating systems such as described above. The remote device 2300 may also include an alphanumeric touch pad 2340. The alphanumeric touch pad 2340 enables individuals to enter passwords and various transaction information. The alphanumeric touch pad 2340 includes a display screen 2350 in which transactions and prompts are displayed.

This particular remote device 2300 is also equipped with a magnetic card strip reader and a “smart card” reader 2360. There will be times when it is necessary to input credit card information into the miniaturized computer 510. The credit card information will be added to the miniaturized computer 510 at registration and when being updated. Instead of having to enter the information manually the remote device 2300 can scan the information directly from the magnetic card strips and the “smart card” chips. This information can then be transmitted directly to the miniaturized computer 510 and stored.

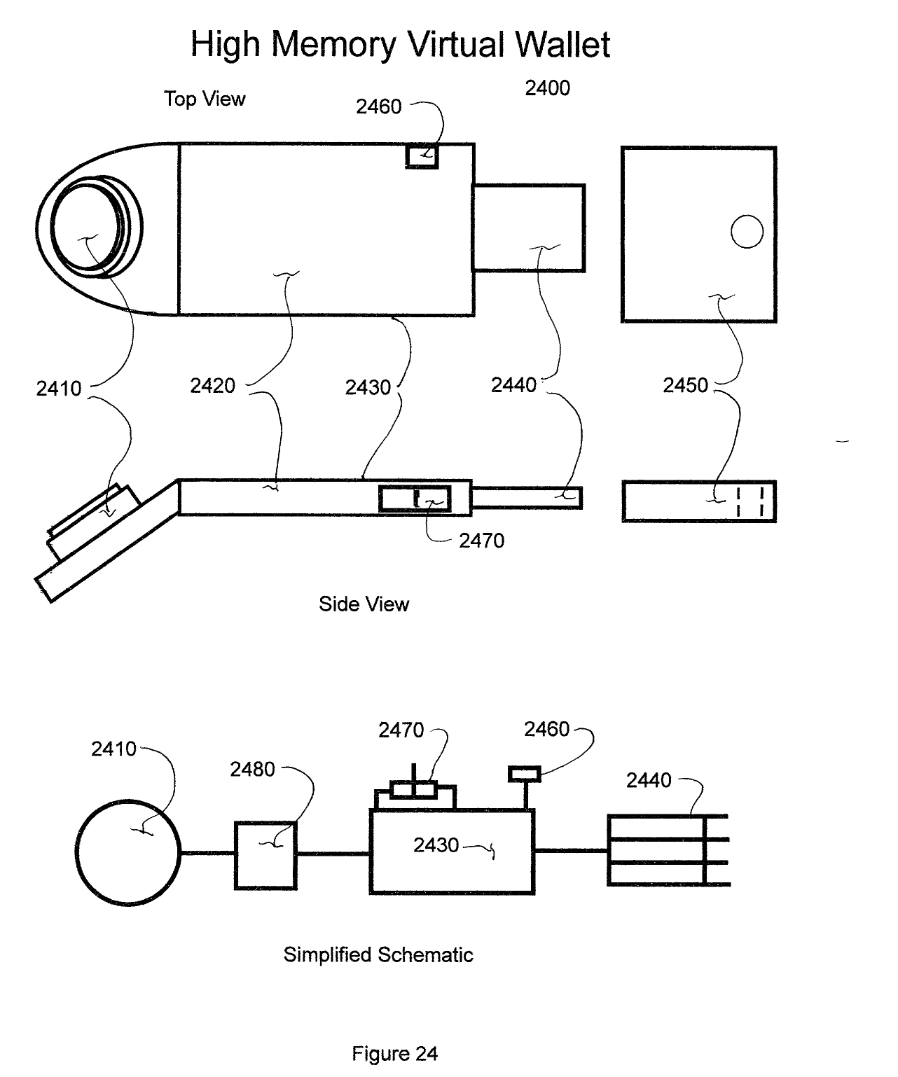

FIG. 24 illustrates a high memory capacity miniaturized computer 2400. This ninth embodiment of the invention consists of several distinct parts. Touch interface 2410 is similar to the safe shown in FIGS. 1A and 1B and acts as the touch interface for the high-speed, high-capacity memory medium 2430. The memory medium 2430 could be a smart card, compact flash, multi-media memory, smart media, memory stick or micro-drive. The memory medium has an LED light 2460 that will light when the memory is being accessed. Access to the memory can be controlled via software and/or through the read/write lock out switch 2470. A USB port 2440 protrudes from one end of the device to facilitate connections to USB ports on computers. A removable cap 2450 protects the USB port 2440. A first processor 2480 is used to process data between the interface 2410 and the memory medium 2430. All of these are housed in the casing 2420. In the future, a wireless transmitter could replace or augment the interface 2410.

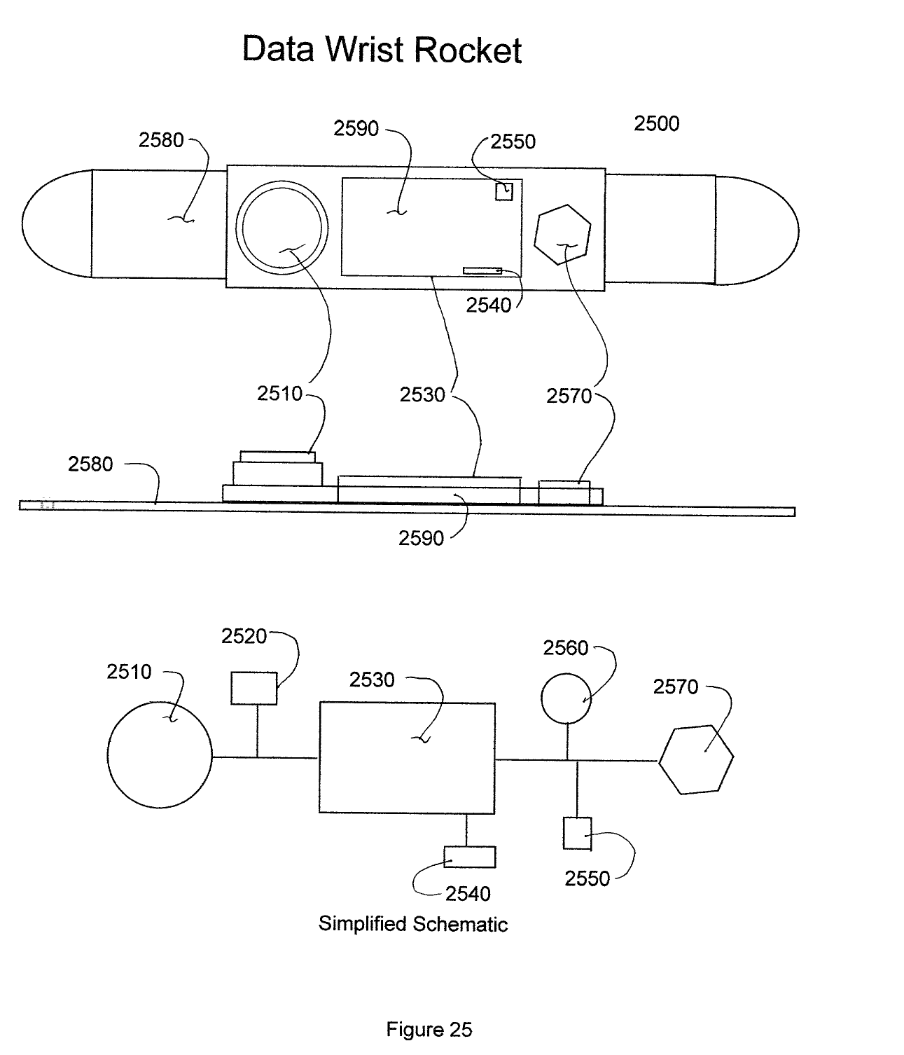

FIG. 25 is the tenth embodiment of the invention where the miniaturized computer is a data wrist rocket portable memory body-wear 2500. The wrist rocket is comprised of a touch interface 2510 similar to 1A and 1B in FIG. 1. The memory medium 2530 could be a smart card, compact flash, multi-media memory, smart media, memory stick or micro-drive. The memory medium has an LED light 2550 that will light when the memory is being accessed. Access to the memory can be controlled via software and/or through the read/write lock out switch 2540. A first processor 2520 is used to translate data between the interface 2510 and the first processor 2520. A wireless transmitter 2570 is connected to the memory medium 2530 to transmit data wirelessly. A battery 2560 for power and back up is also present. The casing 2590 houses all of the components, which are attached to the body via a wristband 2580 or other means such as a belt or ear rings. An optional component could be attached to the wristband or casing such as a watch, radio or pager.

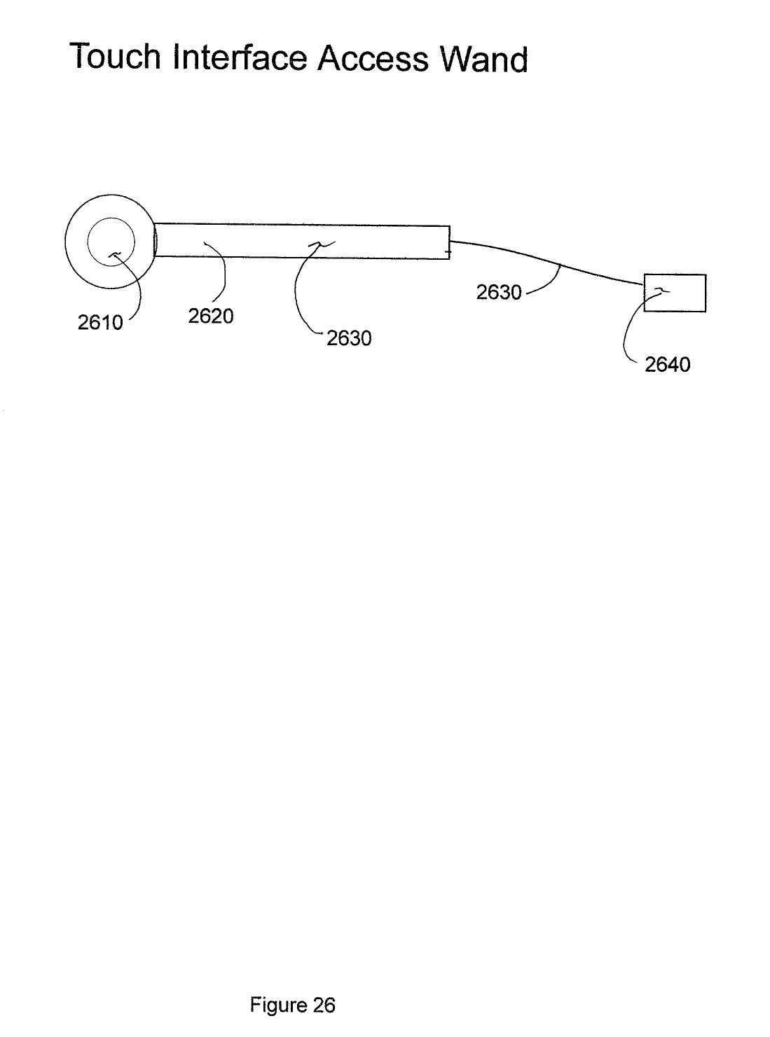

In FIG. 26 an interface access wand 2600 is shown. The wand includes an interface contact 2610 sized to make contact with the safe or interface. Inside the wand body 2630 is a second processor 2620 to translate data from the interface 2610. Data is transmitted via a cable 2630 to the USB connection 2640.

One of the advantages of the present invention is real time updating and changes. Unlike magnetic strip cards or Smart Cards that must be sent off to be changed updating or changes to the Virtual Wallet can be done easily through any appropriately equipped computer. An appropriately equipped computer would be one that would contain a remote device 2300 as shown in FIG. 23 and all of its components in some form. A desktop computer 630 outfitted with a biometric scanner and a data access port 620, FIG. 6 would also suffice.

As shown in FIG. 27, a customer wishes to make a change to the contents of their miniaturized computer 510, FIG. 5 as in step 2710. To change any information or data the security protocols for that information or data must be satisfied. For example to use or access a credit card requires level III security (fingerprint and password) so the same requirements are needed to modify that information. Public data or non-secure data such as text files, pictures, etc. would not require any security protocols. The data is easily retrievable and accessible without additional verification necessary.

First, the remote device 2300 displays all of the files and security protocols as well as file functions such as add, delete, copy, etc. as shown in step 2721. They may also use a personal computer 630 that is equipped with a miniaturized computer remote device 620. If the change does not affect security or financial protocols then the customer can access and modify these files without any further requirements as shown in steps 2720 and 2730. If the change does affect security or financial protocols full Level III security protocol is required to make the change as shown in steps 2720 and 2740. The customer must provide a correct password and fingerprint to proceed. The remote device 2300 will also display the warning: “Warning! Changes to these files requires level III security access.”

If the customer wishes to revise their personal data such as their address, phone number, etc. as in step 2750 the customer inputs the new or revised data as in step 2851. The miniaturized computer 510 saves both the old and new data. The new data is saved under the heading “new.” The new data is then immediately displayed so as to show the new current address, phone number, etc. as in step 2752. The old data is saved for future security references and verification the first time the miniaturized computer 510 is used as in step 2775.

The customer can also change their security information such as passwords or biometric data (fingerprints, DNA, etc.) as shown in step 2760. The customer accesses the change menu and inputs the new password or fingerprint as in step 2765. The miniaturized computer 510 saves the new security protocols as “new” but does not activate the new security protocols as in step 2770. The first time the customer uses the miniaturized computer 510 in a transaction that requires these protocols, i.e. payment, the retail remote device 520, FIG. 5, will not open the miniaturized computer with either the old or new security protocols as in step 2780. The retail remote device 520 displays the warning: “Caution! You must use both your “old & new” password and fingerprint the first time.” as in step 2785.

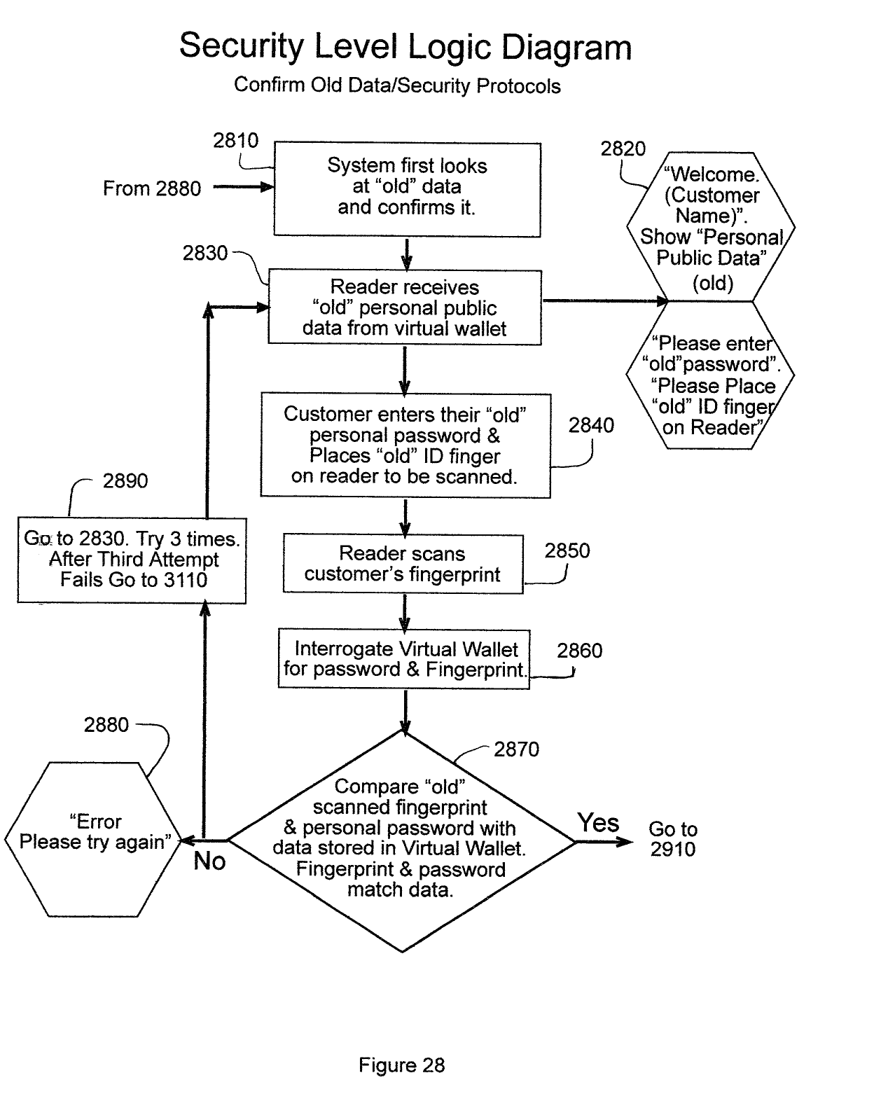

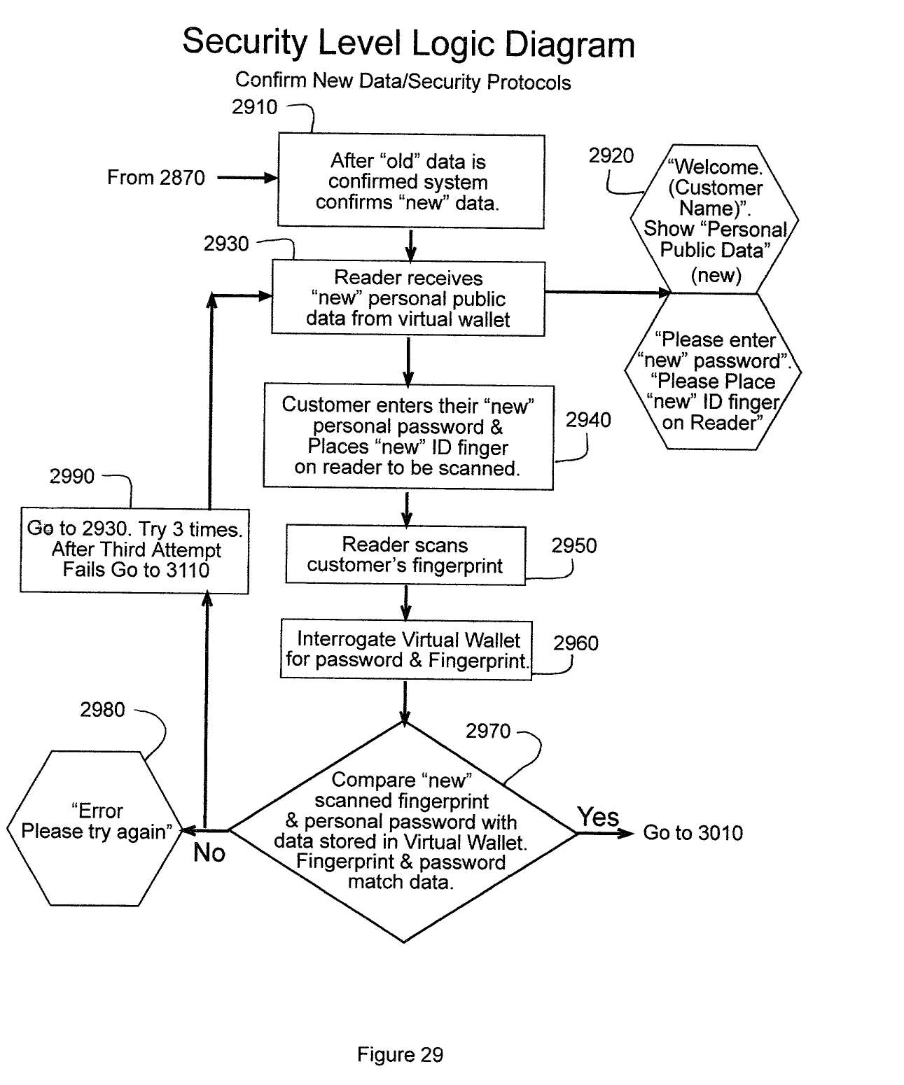

The system first looks at the old data in the miniaturized computer 510 and confirms it as in step 2810 in FIG. 28. The retail remote device 520 retrieves the old data from the miniaturized computer 510 as in step 2830 and displays: “Welcome (customer name) and shows the old personal public data. Please enter your old password and place old ID finger on remote device” as in step 2820. The customer enters their old password and places their old ID finger on the remote device to be scanned as in step 2840. The remote device 520 scans the fingerprint as in step 2850 and then interrogates the miniaturized computer 510 for the old password and fingerprint as in step 2860.

The retail remote device 520 compares the old scanned fingerprint and old password with those stored under “old” in the miniaturized computer 510 as in step 2870. If the two sets of data do not match the retail remote device 520 will display the message: “Error. Please try again” as in step 2880. Steps 2820-2880 are repeated three times as shown in step 2890.

The customer has a set number of times to enter the correct biometric and password criteria. After the final attempt fails, the percentage of error in the biometric identification criteria provided may be calculated. For example the extend to which the entered data is out of calibration as compared to the stored data in the miniaturized computer 510 is measured, as shown in step 3110 in FIG. 31. The out of calibration results and the biometric identification criteria provided are then stored as in step 3120 in the miniaturized computer 510 as in step 3122. The out of calibration results may be used to inform the customer to reenter his biometric identification if the previously stored biometric criteria has changed over time. The results may also be used to keep records of the biometric criteria that is in error. Such records would be helpful as evidence in a criminal proceeding.

Simultaneously, the remote device 520 may display the message: “Unable to confirm identity. Please contact your financial administrator” as in step 3130. The remote device 520 then closes the miniaturized computer 510 as in step 3140. At this point certain automatic security options can be invoked.

As shown in FIG. 28, if the old data presented (fingerprint and password) match the old data in the miniaturized computer 510 as in step 2870 then the old data is confirmed as in step 2910. The retail remote device 520 then retrieves the “new” data from the miniaturized computer 510 as in step 2930. The remote device 520 then displays the message: “Welcome (customer name) and shows the new personal public data. Please enter your new password and place new ID finger on the device as shown in step 2920. The customer enters their new password and places their new ID finger on the remote device 520 to be scanned as in step 2940. The remote device 520 scans the fingerprint as in step 2950 and then interrogates the miniaturized computer 510 for the new password and fingerprint as in step 2960.

The retail remote device 520 compares the new scanned fingerprint and new password with those stored under “new” in the miniaturized computer 510 as in step 2970. If the two sets of data do not match the retail remote device 520 will display the message: “Error. Please try again” as in step 2980. Steps 2920-2980 are repeated three times as shown in step 2990.

The customer has a finite number of times to enter the correct biometric and password criteria. After the final attempt fails, the percentage of error in the biometric identification criteria provided may be calculated. For example the extent to which the entered data is out of calibration as compared to the stored data in the miniaturized computer 510 is measured, as shown in step 3110 in FIG. 31. The out of calibration results and the biometric identification criteria provided are then stored in the miniaturized computer 510 as in step 3122. The out of calibration results may be used to inform the customer to reenter his biometric identification if the previously stored biometric criterion has changed over time. The results may also be used to keep records of the biometric criteria that are in error. Such records would be helpful as evidence in a criminal proceeding.

Simultaneously, the remote device 520 may display the message: “Unable to confirm identity. Please contact your financial administrator” as in step 3130. The remote device then closes the miniaturized computer 510 as in step 3140. At this point certain automatic security options can be invoked.

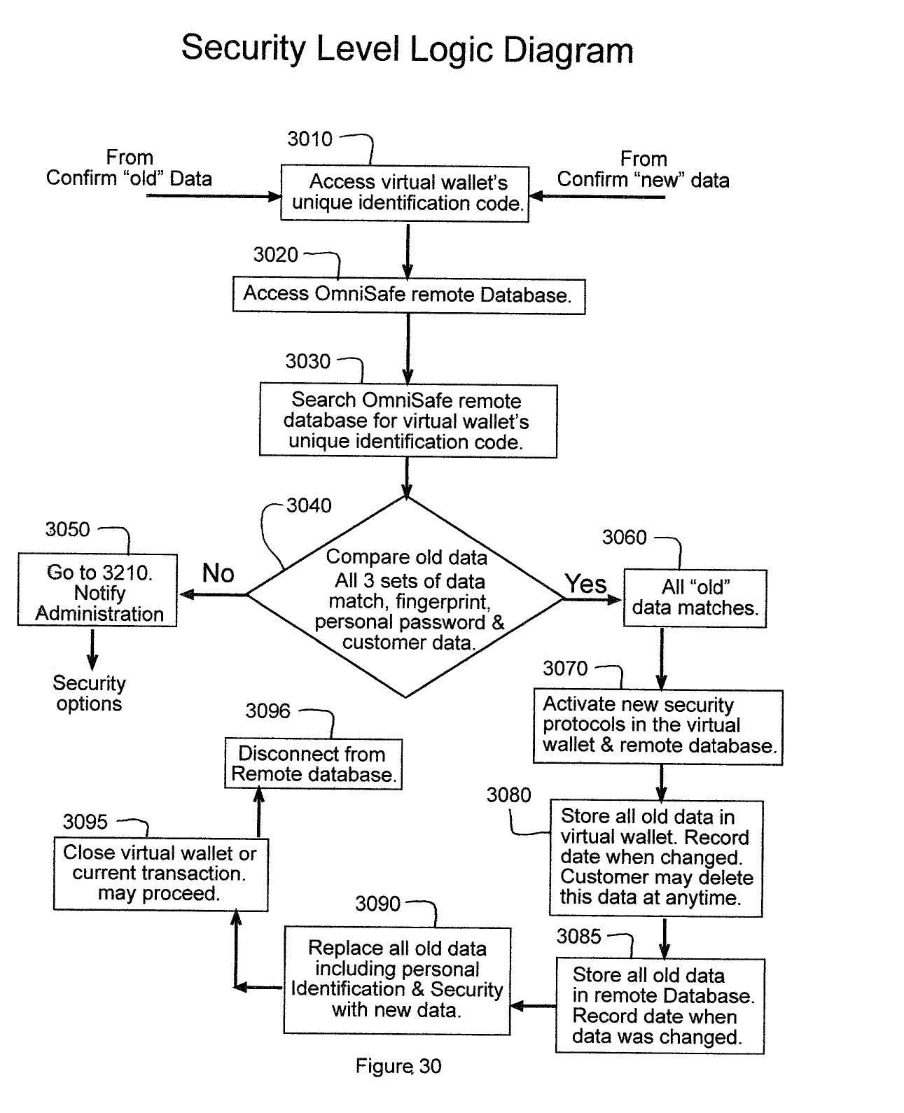

If the new data presented (fingerprint and password) matches the new data in the miniaturized computer 510 as in step 2970 then the remote device 520 accesses the miniaturized computer's unique identifier code as in step 3010, FIG. 30. The retail remote device 520 accesses the remote database 540 as in step 3020 then searches the remote database for the miniaturized computer's unique identifier code as in step 3030. The retail remote device 520 then compares the old confirmed data (fingerprint, password and personal data) in the miniaturized computer 510 with the old data stored in the database 540 as in step 3040.

If the old data matches as in step 3060 then the new security protocols (fingerprint and password) are activated in both the miniaturized computer 510 and the remote database 540 as in step 3070. The old data in the miniaturized computer 510 (fingerprint, password and personal address data) are stored in the miniaturized computer 510 along with a revision date as in step 3080. The customer at anytime can delete this old data from their miniaturized computer 510. In addition the old data is permanently stored in the remote processing unit database 540 along with a revision date as in step 3085. Old data is replaced with the new data as in step 3090. Finally the current financial transaction can proceed and the miniaturized computer 510 is closed as in step 3095 and the connection to the remote processing unit database 540 is terminated as in step 3096.

Referring to step 3040 if the old data does not match the database administrator may be notified as in step 3050. In addition the percentage of error in the biometric identification criteria provided may be calculated. For example the extend to which the entered data is out of calibration as compared to the stored data in the miniaturized computer 510 is measured, as shown in step 3110 in FIG. 31. The out of calibration results and the biometric identification criteria provided are then stored in the miniaturized computer 510 as in step 3122 and in the remote processing unit database 540 as in step 3124. The out of calibration results may be used to inform the customer to reenter his biometric identification if the previously stored biometric criterion has changed over time. The results may also be used to keep records of the biometric criteria that are in error. Such records would be helpful as evidence in a criminal proceeding.

Simultaneously, the remote device 520 may display the message, “Unable to confirm identity. Please contact your financial administrator.” as in step 3130. Automatic security options may be invoked as well. The remote device 520 then closes the miniaturized computer 510 as in step 3140. Then disconnects from the remote processing unit database 540 as in step 3150.

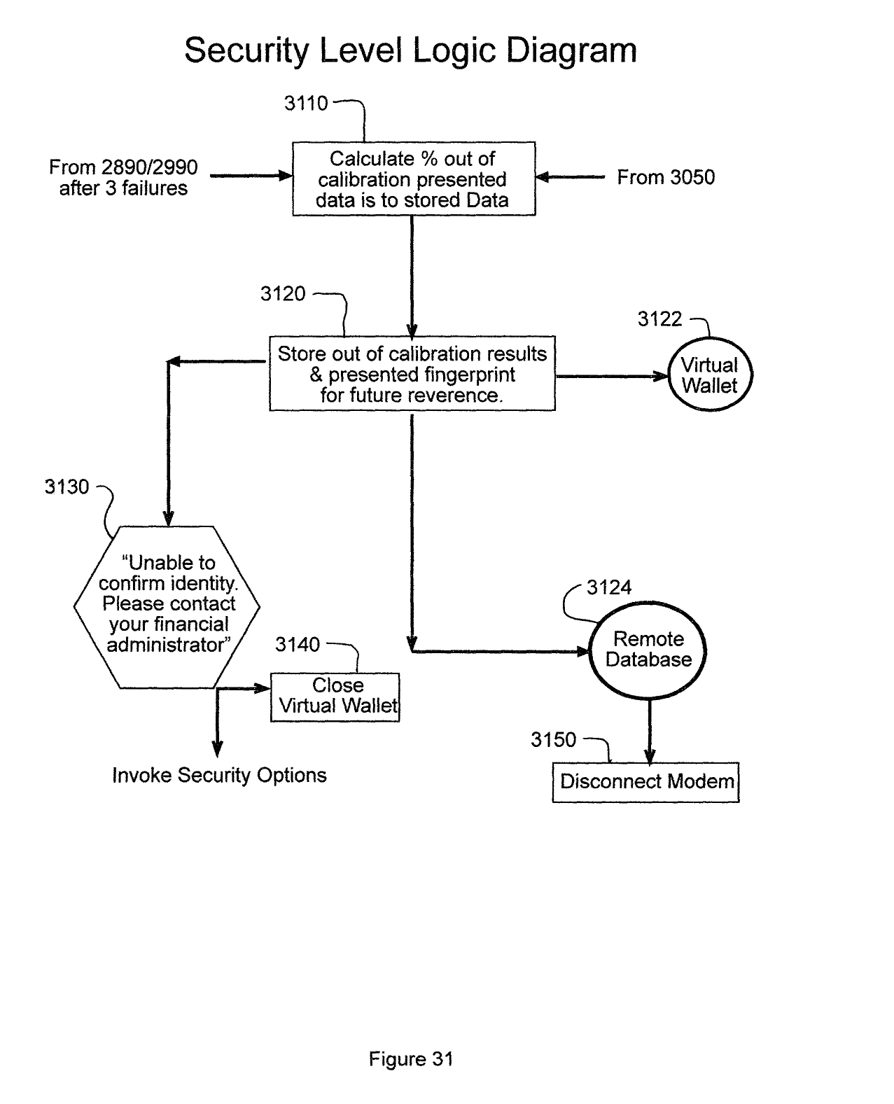

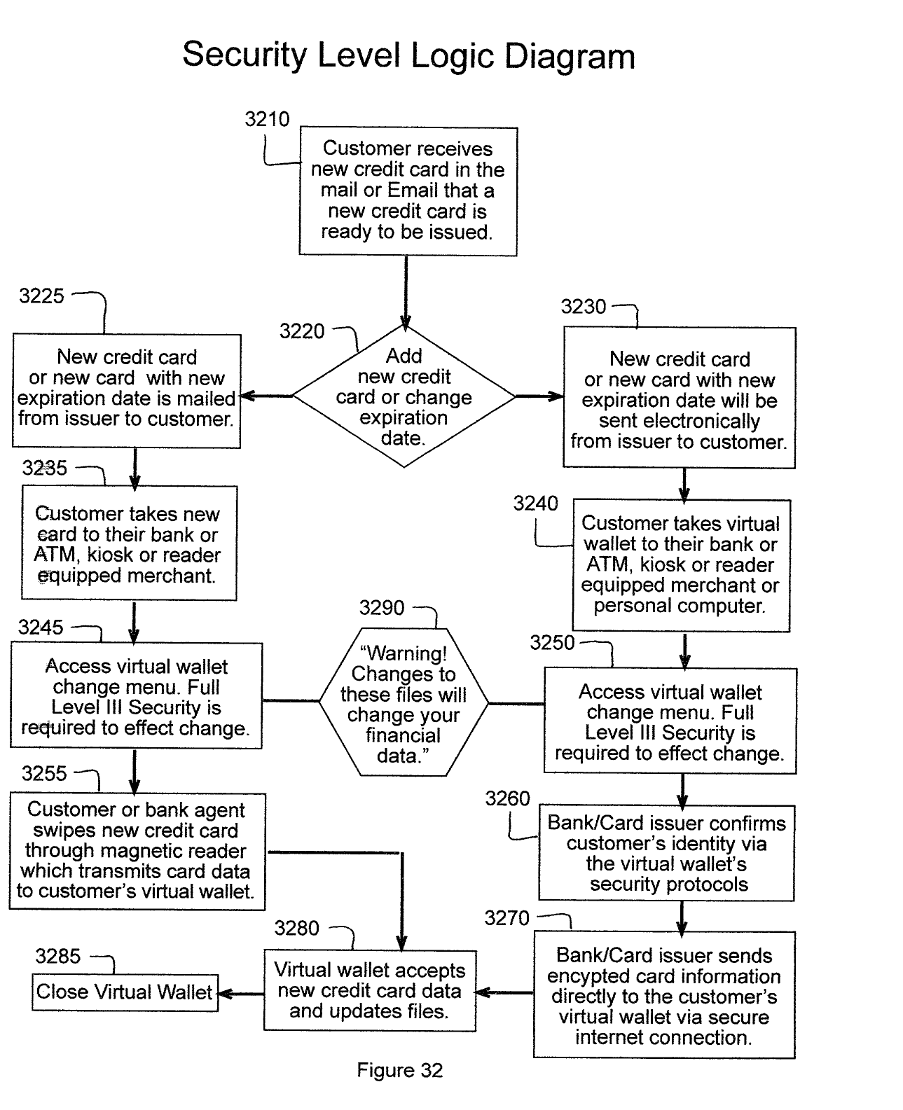

Referring to FIG. 32 the customer receives a new card via mail or notification of a new card via email as in step 3210. The customer decides to add this new or revised credit card to their miniaturized computer 510 as in step 3220. If the new or revised credit card is mailed to the customer as in step 3225 they will take it to their bank, ATM or similar place that is equipped with a credit card reader 2360, FIG. 23 as in step 3235. The example credit card reader 2300 can read the magnetic strip on the back of the card or the “smart card” computer chip and can read/operate a miniaturized computer.

The customer accesses the miniaturized computer 510 change menu. They must satisfy full level III security protocols to complete the change as in step 3245. Simultaneously the remote device 2300 as shown in FIG. 23 will display the message: “Warning! Changes to these files will change your financial data” as in step 3290. The customer or bank agent swipes the new credit card through the magnetic reader 2360, which transmits the new credit card data directly to the customer's miniaturized computer 510 as in step 3255. The miniaturized computer 510 accepts the new credit card data and updates its files as in step 3280 then closes the miniaturized computer 510 as in step 3285.

Referring to FIG. 32 the customer receives a new card via mail or notification of a new card via email as in step 3210. The customer decides to add this new or revised credit card to their miniaturized computer 510 as in step 3220. If the new or revised credit card is to be sent electronically to the customer as in step 3230 they will take it to their bank or ATM that is equipped with a miniaturized computer reader 2300, FIG. 23. They may also use a personal computer 630 that is equipped with a miniaturized computer reader 620 as in step 3240.

The customer accesses the miniaturized computer 510 change menu. They must satisfy full level III security protocols to complete the change as in step 3250. Simultaneously the reader will display the message: “Warning! Changes to these files will change your financial data” as in step 3290. The bank/card issuer confirms the identity of the customer via the miniaturized computer's 510 security protocols as is step 3260. The bank/card issuer then sends encrypted card information directly to the customer's miniaturized computer via secure Internet connection as in step 3270. The miniaturized computer 510 accepts the new credit card data and updates its files as in step 3280 then closes the miniaturized computer 510 as in step 3285.

Because of the real time read/write capability of the miniaturized computer there are security options available to banks and credit card issuers that never existed before. In the past a bad credit card or fraud attempt was difficult to stop in progress. Some of the options available are as follows:

1. Miniaturized computer stores erroneous fingerprints presented both in the wallet and in the remote database;

2. The remote processing unit database only stores active miniaturized computer ID codes. Inactive or fraudulent ID codes are easily spotted;

3. The remote processing unit database can send a list of fraudulent, stolen or deactivated miniaturized computer ID codes to the Point of Sales devices virtually instantaneously;

4. Fraudulent or stolen miniaturized computers can be deactivated remotely the first time they are used;

5. Security can be notified by the remote database thereby protecting the store's personnel;

6. Because the miniaturized computer acts as a single access point for all of a customer's credit cards any lost or stolen wallet automatically closes that door for all of the customer's cards;

7. The remote site administrator is notified of problems and can send a message immediately to the customer if something is wrong or needs correcting; and

8. The customer can setup a “help or emergency code” with in the wallet. Anytime the wallet is used the customer can send this emergency signal in stead of the password to notify authorities of a problem or emergency.

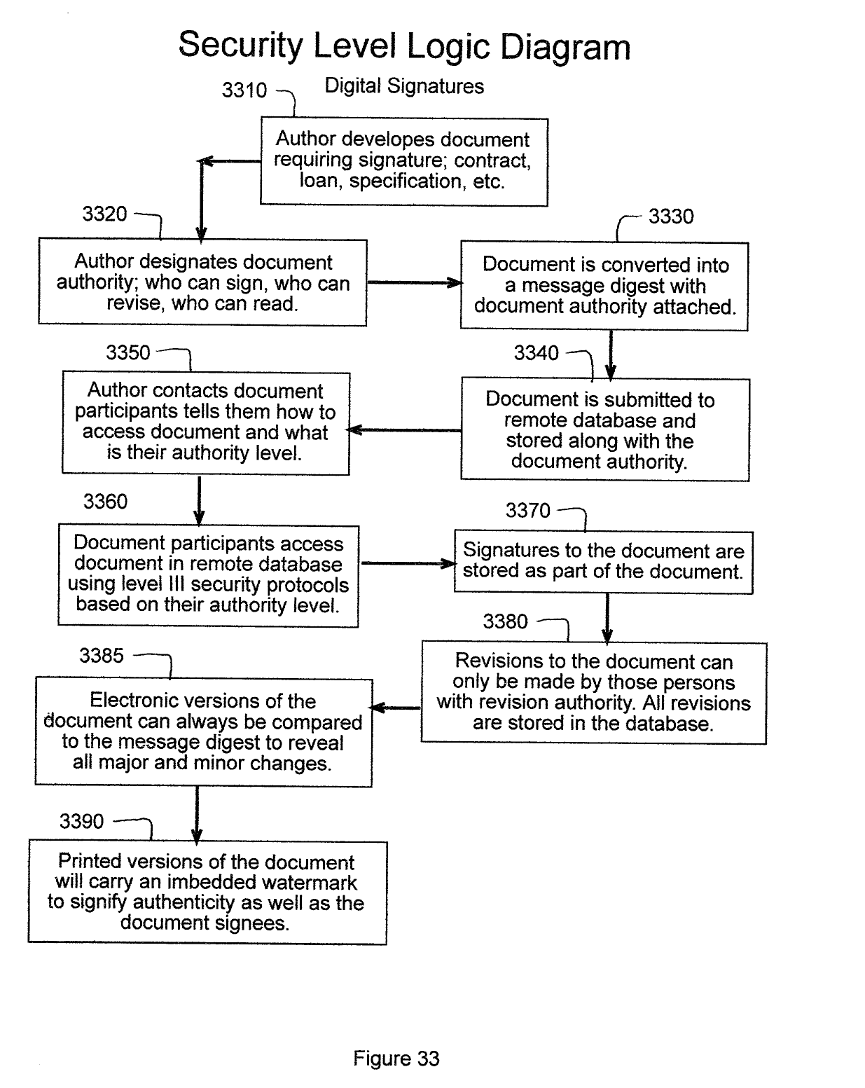

Referring to FIG. 33 an author develops a document that requires a signature; contract, purchase order, loan, specification, etc. as in step 3310. The author designates document authority; who is authorized to sign the document, revise the document, who can read the document, etc. as in step 3320. The document is converted to a message digest, an accurate, abbreviated form of the document, with the document authority attached as in step 3330.

The document is submitted to a remote database and stored along with the document authority as in step 3340. The author contacts the document participants and tells them how to access the document in the remote database and what is their authority level as in step 3350. Document participants access the document in the remote database using their miniaturized computer security level III protocols. This assures the identity of those wishing to read, revise and sign the document as in step 3360. Digital signatures to the document utilize the unique code from the miniaturized computer and the corresponding biometric to identify the signer and are stored as part of the document as in step 3370.

Revisions to the document can only be made by those persons with revision authority. All revisions are stored in the remote database along with their signature authority as in step 3380. Electronic versions of the document can always be compared to the message digest to reveal all major and minor changes as in step 3385. Printer versions of the document will carry an embedded watermark to signify authenticity as well as a list of the document signers as in step 3390.

Referring to FIG. 34 a voter is registered in their county, state or country in accordance with their national, state and local laws as in step 3410. Each registered voter receives a voter token (miniaturized computer 510) that contains their personal information such as name, address, birth date, place of birth, etc. Each token has a unique identifier code that is registered to the voter. The token may also contain the voter's biometric signature; i.e. fingerprint, retina scan as in step 3420.

The voter presents themselves and their voter token to the polling judges when they vote as in step 3430. The polling judges confirm the identity of the voter as in step 3435. The judge reads the information from the voter token. The unique token ID number and voter information is compared to the voter database as in step 3440. The judges may also do a biometric scan and drivers license check to confirm the identity of the voter as in step 3445. The token also displays the election status for that voter “voted in this election yes/no.” If all is in order, identity, registration, status, the judges approve the voter as in step 3450. The approval can be done in the token or by some other method.

The voter proceeds to the voting booth with a ballot and approved voter token as in step 3460. Electronic voting booth reads voter's token and confirms that they have not voted in this election and that they have been approved by the polling judge as in step 3470. The polling booth opens up the internal memory disk in order to tabulate the vote as in step 3475. Voting booth tabulates votes and stores results. It records the ID number of the token to show that this person voted as in step 3480. The voting booth updates the voter token to “voted in this election” then closes the token as in step 3490.

Another method deletes the token and uses the biometric scanner and remote processing unit database to confirm voter eligibility. FIG. 35 illustrates another embodiment of the high memory capacity miniaturized computer with a biometric sensor attached 3500. This enhanced embodiment of the invention consists of several distinct parts. Touch interface 3510 is provided and similar in concept to the safe shown in FIGS. 1A and 1B. An example of the touch interface is Dallas Semi-Conductor ibutton Model Number 1990. The button interface allows a high number of contact touches. These contact touches can be misaligned, off center, etc. and the transmission is still maintained. Damage to sensitive pin and connector is eliminated. The button 3510 transmits data between the microprocessor 3580 and a remote device or POS terminal. A microprocessor or translator chip 3580 (for example Atmel microprocessor) is located within the casing 3520 and is used to translate data between the button 3510 and the memory medium 3530. Biometric data, such as a fingerprint, DNA, or the like, must be presented along with a user selected password in order for the device to activate and allow access to the data. On this enhanced model, the biometric sensor (for example Authentec Model Number AE3500) is physically attached to the microprocessor computer 3580 which eliminates the need for a separate biometric sensor on the POS terminal.

Also as shown in FIG. 35, the memory medium 3530 is a smart card, compact flash, multi-media memory, smart media, memory stick or micro-drive (for example TrekStore Thumb Drive Secure 32 MB). The memory medium has an LED light 3560 that will light when the memory is being accessed. Access to the memory can be controlled via software and/or through the read/write lock out switch 3570. A USB port 3540 protrudes from one end of the device to facilitate connections to USB ports on computers. A removable cap 3550 protects the USB port 3540. All of these are housed in the casing 3520. In the future a wireless transmitter could replace or augment the interface 3510 (for Example SpeedPass Transmitter). The transmitter 3595 would transmit data between the microprocessor 3580 and a receiver located in a remote device or POS terminal.

FIG. 36 illustrates another embodiment 3600 of the high memory capacity miniaturized computer with a biometric sensor attached. This enhanced embodiment of the invention consists of several distinct parts. The touch interface seen in the previous embodiments has been eliminated. The touch interface has been replaced with a wireless or infrared transmitter or similar transmitting device 3610. The transmitter 3610 transmits data between the microprocessor 3680 and a receiver located in a remote device or POS terminal. A microprocessor 3680 (for example Atmel microprocessor) is now located within the casing 3620 and is used to translate data between the transmitter 3510 and the memory medium 3530. Biometric data, such as fingerprint, DNA, or the like, must be presented along with a user selected password in order for the device to activate and allow access to the data. ON this enhanced model the biometric sensor (for example Authentec Model Number AE3500) is physically attached to the microprocessor computer 3680 which eliminates the need for a separate biometric sensor on the POS terminal.

Also as shown in FIG. 36, the memory medium 3630 is a smart card, compact flash, multi-media memory, smart media, memory stick or micro-drive (for example TrekStore Thumb Drive Secure 32 MB). The memory medium has an LED light 3660 that will light when the memory is being accessed. Access to the memory can be controlled via software and/or through the read/write lock out switch 3670. A USB port 3640 protrudes from one end of the device to facilitate connections to USB ports on computers. A removable cap 3650 protects the USB port 3640. All of these are housed in the casing 3620.

The embodiments and examples set forth herein are presented to best explain the present invention and its practical application and to thereby enable those skilled in the art to make and utilize the invention. However, those skilled in the art will recognize that the foregoing description and examples have been presented for the purpose of illustration and example only. The description as set forth is not intended to be exhaustive or to limit the invention to the precise form disclosed. Many modifications and variations are possible in light of the above teaching without departing from the spirit and scope of the following claims.

What is claimed is:

1. A method in a computer system for authenticating the identity of a person, the computer system having a miniaturized computer comprising a memory for storing personal data, an interface and a first processor for receiving and comparing personal data at various security levels, the method of authentication comprising the steps of:
receiving personal data through the interface of the miniaturized computer;
verifying personal data by comparing the personal data received to personal data maintained in the memory of the miniaturized computer; and
displaying the authentication result.

2. The method of claim 1, wherein the miniaturized computer is a voter token used to vote in elections.

3. The method of claim 1, wherein the personal data received through the interface of the computer is a digital signature.

4. The method of claim 1, wherein the computer system is used for processing financial transaction including credit/debit cards, electronic cash transfers and paper money.

5. The method of claim 1, wherein said personal data is password.

6. The method of claim 1, wherein the personal data is biometric.

7. The method of claim 1, wherein an identifier code is maintained in the first processor.

8. The method of claim 1, wherein personal data is verified in a remote processing unit, said remote processing unit communicably linked to a remote device for receiving data from said miniaturized computer.

9. A computer system for authenticating identity of person, comprising:
a miniaturized computer having a memory, a first processor and an interface for receiving and transmitting personal data, the interface being communicably linked to said first processor, wherein said miniaturized computer verifies said personal data to authenticate the identity of the person; and
a remote device having a reader and an interpreter, said interpreter having a second processor for authorizing an action or a transaction.

10. The computer system of claim 9, further comprising a remote processing unit for authenticating the personal data, said remote processing unit verifies personal data, said remote processing unit being communicably linked to said remote device.

11. The system of claim 9, wherein the miniaturized computer is maintained in a piece of jewelry.

12. A computer system for authenticating identity of person, comprising:
a miniaturized computer having a memory for storing an identifier code, a first processor and an interface for receiving and transmitting personal data, the interface being communicably linked to said first processor, wherein said miniaturized computer verifies the personal data to authenticate the identity of the person;
a remote device having a reader and an interpreter, said interpreter having a second processor for authorizing an action or a transaction.; and
a remote processing unit communicably linked to said remote device.

13. The computer system of claim 12, wherein the computer interface comprises a receiver for receiving personal data.

14. The computer system of claim 13 wherein said receiver is capable of scanning fingerprints, retina, DNA, or a face of an individual or a voice of an individual.

15. The miniaturized computer of claim 13, wherein said receiver comprises a biometric scarmer.

16. The miniaturized computer of claim 12 wherein said interface further comprises a transmitter for sending data to said remote device.

17. A memory for storing data for access by a computer readable program being executed on a computer, comprising:
a data structure stored in said memory, said data structure including information resident in a database used by the computer readable program and including: personal information, credit card information, medical information, nonpublic identification information, electronic currency, and identifier code.

18. The memory for storing data of claim 17, wherein said data structure further includes: business card information, and encryption information.

19. The computer system for authenticating identity of claim 9, wherein said interface is a mechanical interface for receiving and sending data.

20. A portable miniaturized computer for authenticating the identity of a person and to process transactions that require proof of identification and access to other personal data comprising:
a first processor having a high capacity memory wherein a personal data is maintained in said memory; and
an interface for communicating personal data from a receiver to said first processor and transmitting data to a remote device.

21. The miniaturized computer of claims 9 or 20, wherein said interface comprises a wireless transmitter communicably connected to a remote device.

22. The portable miniaturized computer of claim 20, further comprising security protocol said security protocol are selected from the group consisting of a unique identifier code embedded in the computer, a password, biometric identification criteria, confirmation of identity with a remote database, remote shutdown of the computer, and storage of incriminating data.

23. A computer-readable medium containing instructions for controlling a computer to authenticate the identity of a person, by:
receiving personal data through an interface of a portable miniaturized computer, said computer accessing and processing the data for making transactions or actions that require proof of identification and other personal data;
verifying personal data by comparing the data to an identifier code maintained in the memory of the miniaturized computer; and
displaying the authentication results.
